(19) United States
(12) Patent Application Publication
(10) Pub. No.: US 2009/0064201 A1
(43) Pub. Date: Mar. 5, 2009

(54) Image Forming Apparatus, Application Management Method, and Computer-Readable Recording Medium Having Application Management Program

(75) Inventor: Kazuhide Tanabe, Kanagawa (JP)

Correspondence Address: IPUSA, P.L.L.C, 1054 31ST STREET, N.W., Suite 400, Washington, DC, 20007, US

(73) Assignee: RICOH COMPANY, LTD.

(21) Appl. No.: 12/200,986

(22) Filed: Aug. 29, 2008

(30) Foreign Application Priority Data
Sep. 3, 2007 (JP) 2007-228093

(51) Int. Cl. G06F 9/46

(52) U.S. Cl. 719/328

(57) ABSTRACT

An image forming apparatus includes an output order control unit, wherein an application executed in the image forming apparatus is constructed by connection of a first software unit executing at least a process related to input of image data and a plurality of second software units executing a process related to output of the image data, and the output order control unit determines an execution order of the plural second software units, based on output order information indicating the execution order of the plural second software units.

### BACKGROUND OF THE INVENTION

1. Field of the Invention

This invention relates to an image forming apparatus, an application management method, and a computer readable recording medium having an application management program.

2. Description of the Related Art

In recent years, image forming apparatuses such as multi-function apparatuses achieving functions of a printer, a copier, a scanner, a facsimile, or the like have included conventional computers as well as CPUs (central processing units), and each function having been provided by controlling applications in spite of limitations such as memory capacity or the like.

For example, in an image forming apparatus described in the patent document 1 (Japanese Patent No. 3679349), the image forming apparatus includes functions commonly used by each of applications as a platform, and by using an application program interface (API) of the platform, the image forming apparatus can include the applications. Such an image forming apparatus can improve an efficiency of developing total applications because commonly used functions are provided in the image forming apparatus as the platform, so that duplicating functions can be avoided.

However, in general, a platform including a commonly used API tends to have difficulty that does not improve the efficiency of the application development when functions or each of interface grain sizes provided by the platform is not properly designed.

For example, when each grain size is too small, the source code of an application becomes complicated because a large number of APIs need to be requested to process the application even though the application only provides a simple service.

On the other hand, when each grain size is too big, development man-hours can be increased as the platform needs to be modified within the platform itself, when one desires installing an application serving a function for which part of the function provided by an interface is modified. Particularly, when each module in the platform depends on other modules, not only additional new functions but also modifying existing parts in the platform are required. This would make everything complicated.

Also, when one requires mounting applications by modifying part (for example, input process of an image) of a service provided with existing applications, the existing applications cannot be used as the rest of the part of the service. Therefore, new source code needs to be written to generate new applications for mounting

The present invention is carried out by considering the above difficulties, and this invention may provide an image forming apparatus, an application management method, and a computer readable recording medium which are capable of customizing functions and simplifying expandability of the functions.

### SUMMARY OF THE INVENTION

According to one aspect of the present embodiment of the invention, an image forming apparatus includes an output order control unit, wherein an application executed in the image forming apparatus is constructed by connection of a first software unit executing at least a process related to input of image data and a plurality of second software units executing a process related to output of the image data, and wherein the output order control unit controls an execution order of the plural second software units, based on output order information indicating the execution order of the plural second software units.

According to another aspect of the present embodiment of the invention, an image forming control method includes the steps of (a) executing at least a process related to input of image data using a first software unit; (b) executing a process related to output of the image data using a plurality of second software units; and (c) controlling an execution order of the plural second software units, based on output order information indicating the execution order of the plural second software units.

According to another aspect of the present embodiment of the invention, a computer readable recording medium having instructions executable by a computer to execute an image forming control includes executing at least a process related to input of image data using a first software unit; executing a process related to output of the image data using a plurality of second software units; and controlling an execution order of the plural second software units, based on output order information indicating the execution order of the plural second software units.

Customizing functions and extending functions may be simply provided by this image forming apparatus.

Accordingly, the present invention may provide an image forming apparatus capable of customizing functions or extending functions of applications, methods of application management, and application management programs.

Other objects, features and advantages of the present invention will become more apparent from the following detailed description when read in conjunction with the accompanying drawings.

### BRIEF DESCRIPTION OF THE DRAWINGS

FIG. 1 is a diagram showing an embodiment of a software construction of a multi-function apparatus according to the present embodiment;

FIG. 2 is a diagram for describing a concept of a pipe and a filter;

FIG. 3 is a diagram showing an example of a combination of filters enabling each function of a multi-function apparatus according to the present embodiment;

FIG. 4 is a diagram for describing components of a filter;

FIG. 5 is a diagram for describing components of activity;

FIG. 6 is a diagram for showing an example of class constructions with respect to document processing between activity logic and filter logic;

FIG. 7 is a diagram for showing filter connecting relations of multi output activities;

FIG. 8 is a diagram for showing an example of filter constructions of a copier accumulating function;

FIG. 9 is an illustration for showing an example object diagram to describe operational conditions of the copier accumulating function;

FIG. 10 is an illustration showing an example of a document operation job of the copier accumulating function;

FIG. 11 shows an activity diagram to describe a concept of an executing process of a document operation;

FIG. 12 is a diagram for describing job tree generations based on condition trees;

FIG. 13 is a sequential diagram for describing a generation process of condition trees;

FIG. 14 is a sequential diagram for describing a generation process of condition trees;

FIG. 15 is a diagram for showing condition trees generated in a generation process of condition trees;

FIG. 16 is a sequential diagram for describing job tree generation and an execution process of jobs;

FIG. 17 is a sequential diagram for describing job tree generations and an execution process of jobs;

FIG. 18 is a diagram for showing corresponding information between a filter condition object and a filter job object;

FIG. 19 is a diagram showing a corresponding table between filters and pipes;

FIG. 20 shows a flowchart for describing setting processes in the order of output for multiple outputs by a request management part;

FIG. 21 shows a flowchart for describing selection processes of filter jobs related to outputs that are initially executed by a request management part;

FIG. 22 is a sequence diagram for describing execution processes of filter jobs;

FIG. 23 is a sequence diagram for describing execution processes of filter jobs;

FIG. 24 shows a flowchart for describing a process sequence of event processes by a document operation job object;

FIG. 25 shows a flowchart for describing a process sequence of event processes by a document operation job object when receiving interruption events;

FIG, 26 shows a flowchart for describing a switching process to resource release propriety judgment and interruption state of document operation job by document operation job object;

FIG. 27 is a flowchart for describing a process sequence of an event process by job start trigger object; and

FIG. 28 shows an example of a hardware construction of a multi-function apparatus related to the present embodiment.

### DETAILED DESCRIPTION OF THE PREFERRED EMBODIMENTS

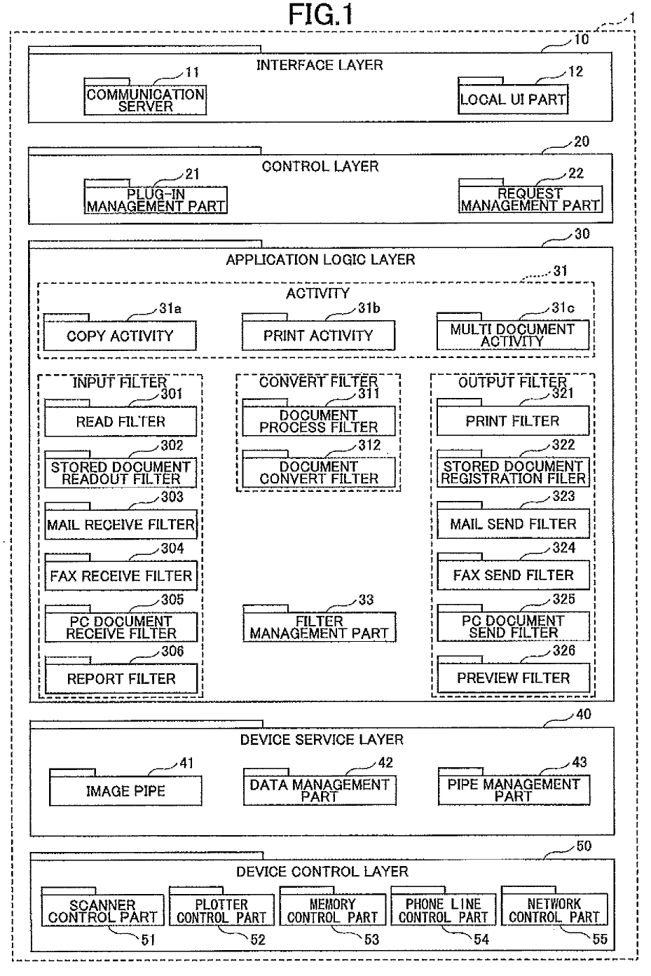

In the following, embodiments of this invention are described with reference to the figures. FIG. 1 shows an example of software construction of a multi-function apparatus of an embodiment of this invention; where the multi-function apparatus is an image forming apparatus which performs plural functions of apparatuses such as a printer, a copier, a scanner, a facsimile or the like by one apparatus alone.

As shown in FIG. 1, software of a multi-function apparatus 1 includes a user interface layer 10, a control layer 20, an application logic layer 30, a device service layer 40, and a device control layer 50. Further, a relation of each layer between an upper layer and a lower layer shows a relation of calls between layers. Therefore, in the figure, a higher layer calls a lower layer.

The interface layer 10 includes a function to receive an execution request of other functions (for example, copying, printing, scanning, sending FAX), such as a communication server 11 and a local UI part 12. The communication server 11 receives a request via a network from a client PC (Personal Computer, not shown) or the like. For example, the local UI part 12 receives a request input with an operation panel (not shown). The request received by the user interface layer 10 is sent to the control layer 20.

The control layer 20 includes a control function to perform a requested function, such as a plug-in management part 21 and a request management part 22. The plug-in management part 21 controls processes (plug-in process) of setting an activity 31 and filters of the application logic layer 30 to an available state. The request management part 22 controls a process to perform functions of the multi-function apparatus 1 in response to a request received by the user interface layer 10. Further, in the embodiment of this invention, “a function of the multi-function apparatus 1” corresponds to a unit service (from a request input to a finally obtained output) serving a series of services to a user by the multi function apparatus 1, and corresponds to an application serving a series of service as a unit software.

The application logic 30 includes a group of parts that individually perform a part of the functions provided with the multi-function apparatus 1. In short, a function is performed by combining the parts of the application logic 30. In the present embodiment, each part is named as “a filter”, which is based on a concept that software architecture of the multi-function apparatus 1 is called “pipe & filter.”

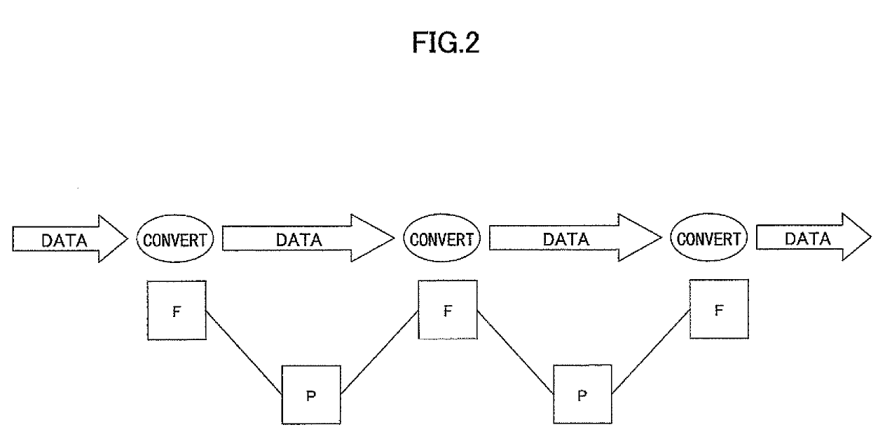

FIG. 2 is an illustration to describe the concept of the pipe & filter. In FIG. 2, “F” indicates a filter and “P” indicates a pipe. Each filter is connected via pipes as shown in the figure. The filter converts input data and outputs the result. The pipe transmits the data output by the filter to a following filter.

Therefore, for the multi-function apparatus 1 of this embodiment, each function is treated as a series of “conversions” to a document (data). Each function of the multi-function apparatus 1 is generalized as a structure constructed with an input, a process, and an output of a document. When the “input”, “process”, and “output” are treated as a “conversion”, a software part performing a single “conversion” forms a filter. A filter inputting a data from a device is specifically called an “input filter.” Also, a filter processing (image processing or the like) data is named as a “conversion filter.” Further, a filter outputting data to a device is called an “output filter.” In this case, each filter is separated and there is no mutual dependence between the filters (call-relation). Therefore, each filter may be added (installation) or deleted (uninstallation) as a unit.

In FIG. 1, the application logic 30 includes as input filters a read filter 301, a saved document read filter 302, a mail receive filter 303, FAX receive filter 304, PC document receive filter 305, a report filter 306, and the like.

The read filter 301 controls a scanner reading image data and outputs the image data read by the scanner. The saved document read filter 302 reads document data (image data) from a memory device of the multi-function apparatus 1 and outputs the read data. The mail receive filter 303 receives an e-mail and outputs data included in the e-mail. The fax receive filter 304 controls receiving a FAX and outputs received data. The PC document receive filter 305 receives print data from a PC (not shown) and outputs the received print data. The report filter 306 outputs setting information, operation history information or the like of the multi-function apparatus l, for example, as data formatted to a table.

Also, a document process filter 311 and a document converter filter 312 belong to converter filters. The document process filter 311 performs a predetermined image conversion process (summary, enlargement, reduction or the like) for input data and outputs the results. The document converter filter 312 performs a rendering process. In short, input PostScript data are converted to bit map data.

Also, an output filter includes a print filter 321, a saved document registration filter 322, a mail sending filter 323r a FAX sending filter 324, a PC document sending filter 325, and a preview filter 326.

The print filter 321 outputs (print) input data with a plotter. The saved document registration filter 322 saves input data into a hard disk in the multi-function apparatus 1. The mail sending filter 323 sends input data with e-mail as an attachment. The FAX sending filter 324 sends input data via a FAX. The PC document sending filter 325 sends input data to a client PC. The preview filter 326 displays input data on an operational panel of the multi-function apparatus 1.

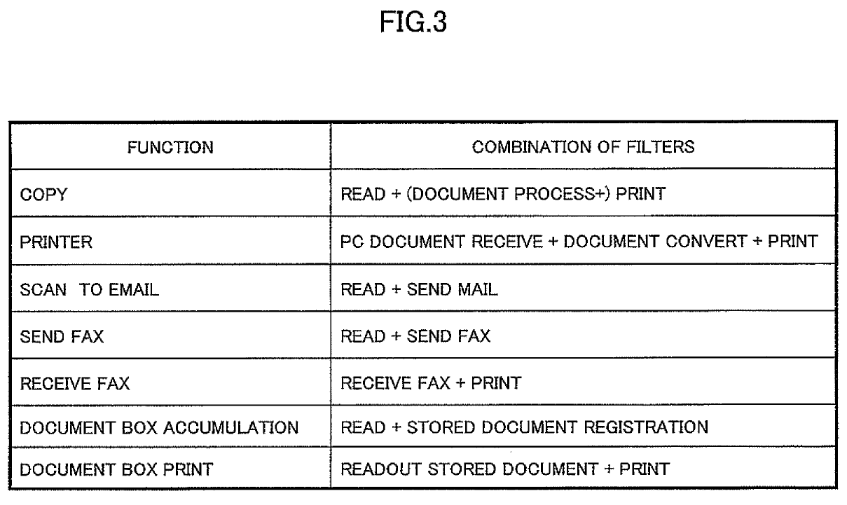

For example, each function of the multi-function apparatus 1 is performed by the following combination of filters. FIG. 3 is an illustration showing an example of the combination of filters to perform each function of the multi-function apparatus of this embodiment.

As an example, a copy function is performed by connecting the read filter 301 and the printing filter 321. Image data is read from a manuscript by the reading filter 301 and printed by the print filter 321. Further, if the copy function is requested to perform summation, enlargement, or reduction of an image, the document process filter 311 is inserted between the two filters.

The printing function (printing function from a client PC) is achieved by connecting the PC document receive filter 305, the document conversion filter 312 and the print filter 321. A scan-to-email function (function of forwarding a scanned image via an e-mail) is achieved by connecting the read filter 301 and the mail sending filter 323. A FAX sending function is achieved by connecting the read filter 301 and the FAX sending filter 324. A FAX receiving function is achieved by connecting the FAX receiving filter 304 and the print filter 321. A document box store function (function of storing scanned image data in the multi-function apparatus 1) is achieved by connecting the read filter 301 and the saved document registration filter 322. A document box print function (function of printing image data saved in the multi-function apparatus 1) is achieved by connecting the saved document read filter 302 and the print filter 321.

In FIG. 3, for example, the read filter 301 is used for five functions. In this manner, each filter is available to be used by plural functions and thus the man-hours for developing, respective functions can be reduced. For example, a copy function and a scanning function (document box store) are used to individually include similar interfaces for setting each operational condition. Notwithstanding, when individual functions are constructed with applications, user interfaces are separately constructed in the applications. However, according to the multi-function apparatus 1 of this embodiment, settings of the copy function and the scanning function are performed by the interface of the read filter 301, so that the interface may be used in common.

Further, suppose that a new function is to be performed. First, as a function 1, suppose that when a print function of printing print data being sent from a client PC is achieved by PDL (Page Description Language, hereafter, “outside PDL”) which is not compatible to the multi-function apparatus 1. In such case, the print function of FIG. 3 is used as a model. However, for the print function of FIG, 3, the data output by the PC document receiving filter 305 is predetermined to have a PostScript format, because the document converter filter 312 processes PostScript data format. On the other hand, for the function 1, data received by the PC document receiving filter 305 and output by the filter has the external (outside) PDL format. Consequently, when the data is forwarded to the document converter filter 312, the document converter filter 312 does not properly process. In such a case, if a new converter filter (hereafter, “external PDL-PS converter filter”) converting the outside PDL format into PostScript format is constructed and inserted between the PC document receiving filter 305 and the document converter filter 312, the function 1 can be achieved. In short, the function 1 can be achieved by connecting the PC document receiving filter 305, the external PDL-PS converter filter, the document converter filter 312 and the print filter 321.

Next, as a function 2, suppose that information is collected from Web sites and the collected information is to be printed by the function (hereafter, “function 2”). In that case, there is no filter collecting information from Web sites. Thus, it is at least necessary to newly construct an input filter (hereafter “Web collecting filter”). Further, since the function 2 is required to print, the print filter 321 is suitable to use as an output filter. In such a case, there may be a problem of how the Web collecting filter and the print filter 321 are connected. The input data of the print filter 321 needs to be in a rendering bitmap format. However, it is not suitable to construct the rendering function within the Web collecting filter because such construction needs man-hours. Then, it is considered whether to use the document converter filter 312 that performs the rendering function. Even in such a case, the input data of the document converter filter 312 needs to be in PostScript format. If the Web collecting filter is configured to output with PostScript format, it becomes possible to connect between the Web collecting filter and the document converter filter 312. When the Web collecting filter is configured in this manner, the function 2 can be achieved by connecting the Web collecting filter, the document converter filter 312 and the print filter 321.

Thus, since the multi-function apparatus 1 is configured to include each function as each filter, customizing functions and extending functions can simply be carried out. In short, since there is no functional dependence between respective filters, independence is maintained, and additional functions (applications) can be easily developed by adding a new filter or modifying combination of filters. Therefore, when a new application is requested to be constructed and part of the new application is not included in the multi-function apparatus 1, only a filter needs to be developed to achieve the process of the part of the new application and the filter may be installed in the multi-function apparatus 1. Accordingly, for layers below the control layer 20 and the application logic layer 30, frequent modifications needed in response to construction of new applications may be reduced and a stable platform can be provided.

The application layer 30 also includes a filter management part 33. The filter management part 33 manages list information of filters installed in the multi-function apparatus 1 or the like. The list information is, for example, recorded in a memory area (memory area of a memory device) managed by the filter management part 33 when filters are installed in the multi-function apparatus 1.

The application layer 30 further includes activity 31. “Activity” is software performing one “function” (a unit service or an application provided by the multi-function apparatus 1 for a user) by combining multiple filters.

Specifically, filters have independence, so that a dynamic combination of filters (application) is possible. More specifically, functions favorable to a user may be performed by the user who sets filters to be used, executing sequences of the filters and operating condition of each filter via an operation panel of the multi-function apparatus 1 every time the multi-function apparatus 1 receives a request for performing a job.

However, for a function frequently used like a copy function, it is complicated for the user to select filters and instruct execution every time. Such a problem is solved by activity 31. In short, once the combination of filters is predetermined as the activity 31, the user can select the activity 31 as a unit executable object. The selected activity 31 automatically executes respective filters combined as a predetermination by the activity 31. Therefore, the activity 31 can reduce the complicated operation for the user and provide easy operation which is similar to conventional user interfaces, where the executable object is selected as a unit application.

In the figure, as the activity 31, copy activity 31a, printer activity 31b, and multi document activity 31c and the like are shown as an example.

The copy activity 31a is achieved by combining the read filter 301, the document process filter 311 and the print filter 321 and performs the copy function (copy application) as one of the activities 31.

The print activity 31b is achieved by combining the PC document receiving filter 305, the document converter filter 312 and the print filter 321 and performs the print function (print application) as one of the activities 31.

The multi document activity 31c is capable of individually combining an input filter, a converter filter and an output filter for each document as one of the activities 31.

Further, each activity 31 is independent from each other, and basically there is no dependence (call-answer relation) between the activities 31. Therefore, a single activity 31 can be added (install) or deleted (uninstall) as a unit. Then, without the activity 31 shown in FIG. 1, another activity 31 may be generated by combining each filter and installed when necessary.

For executing the activity 31, a filter to be used is not fixed (not always the same) and may be changed according to the operating condition set to the activity 31.

A device service layer 40 is constructed with lower functions that are commonly used by each filter such as each activity 31 in the application logic layer 30. For example, an image pipe 41, a data management part 42, a pipe management part 43 and the like are included in the device service layer 40. The image pipe 41 achieves the pipe function described above. In short, the image pipe 41 transfers output data of a filter to another filter. The data management part 42 describes each database, corresponding to, such as, database registered with user information, database stored with documents, image data and the like. The pipe management part 43 manages list information of types of pipes available in the multi-function apparatus 1 or the like. As described below, there are different types of pipes. The list information is, for example, stored in a memory area (on area of a memory device) managed by the pipe management part 43.

A device control layer 50 is constructed with program module groups controlling devices (hardware) called drivers including, for example, a scanner control part 51, a plotter control part 52, a memory control part 53, a TEL line control part 54, and a network control part 55.

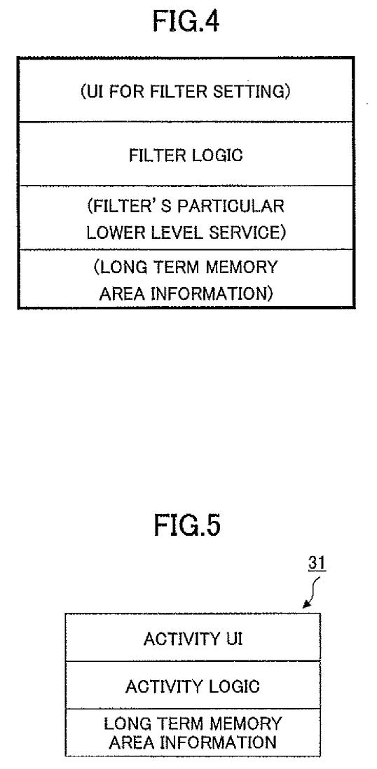

Filters and the activity 31 are described below in more detail. FIG. 4 is a drawing to show constituent elements of a filter. As shown in FIG. 4, each filter is constructed with a filter setting UI, filter logic, a filter specific lower service, and long term memory area information and the like. For these elements, the filter setting UI, a filter specific lower service and the long term memory area information are not included in every filter as constituent elements.

The filter setting UI is a program to display filter operational condition and the like on the operation panel or the like. For example, for a read filter 301, resolution, density, a setting display of image types and or the like correspond to the filter setting UI. Further, since the display on the operational panel is based on HTML data or the script, the filter setting UI may be HTML data or the script.

The filter logic is a program provided with logic to achieve functions of a filter. In short, by using the filter specific lower service, the device service layer 40, the device control layer 51 or the like, the function of a filter is achieved according to the operational condition set via the filter setting UI. For example, for the read filter 301, logic of controlling reading a manuscript by a scanner corresponds to the filter logic.

The filter specific lower service is a lower function (library) required to achieve filter logic. Namely, the filter specific lower service corresponds to a function of the device service layer 40 or the device control layer 50. When a function of the filter specific lower service is not used by other filters, the function may be used as part of a filter, and the part of the filter corresponds to the filter specific lower service. In the read filter 301, the function controlling a scanner corresponds to the filter specific lower service, and in this embodiment, the function is installed as the scanner control part 51 in the device control layer 50. Therefore, the read filter 301 may not always need the filter specific lower service.

The long term memory area information is a schema definition of data such as setting information (e.g. default values of operation condition) for a filter required to be stored in a nonvolatile memory. The schema definition is registered in the data management part 42 when the filter is installed.

FIG. 5 is an illustration to describe components of the activity. As shown in FIG. 5, the activity 31 is constituted by activity UI, activity logic, long term memory area information and the like.

The activity UI is a program or information to display a screen (e.g. a setting screen for setting the operational conditions or the like of the activity 31) regarding the activity 31 on an operational panel or the like.

The activity logic is a program in which process contents of the activity 31 are installed. Basically, logic related to combination of filters (e.g., execution sequence of filters, settings related to plural filters, modification of connections of filters, error processing or the like) are installed in the activity logic.

The long term memory area information corresponds to schema definition of data for the activity 31 required to save in a nonvolatile memory, such as setting information (e.g. default values of operational condition) or the like. The schema definition is registered in the data management part 42 when the activity 31 is installed.

As shown in FIG. 4 or FIG. 5, logic performing functions of filters are installed in the filter logic and the activity logic. Further, the filter logic and the activity logic are described in the following.

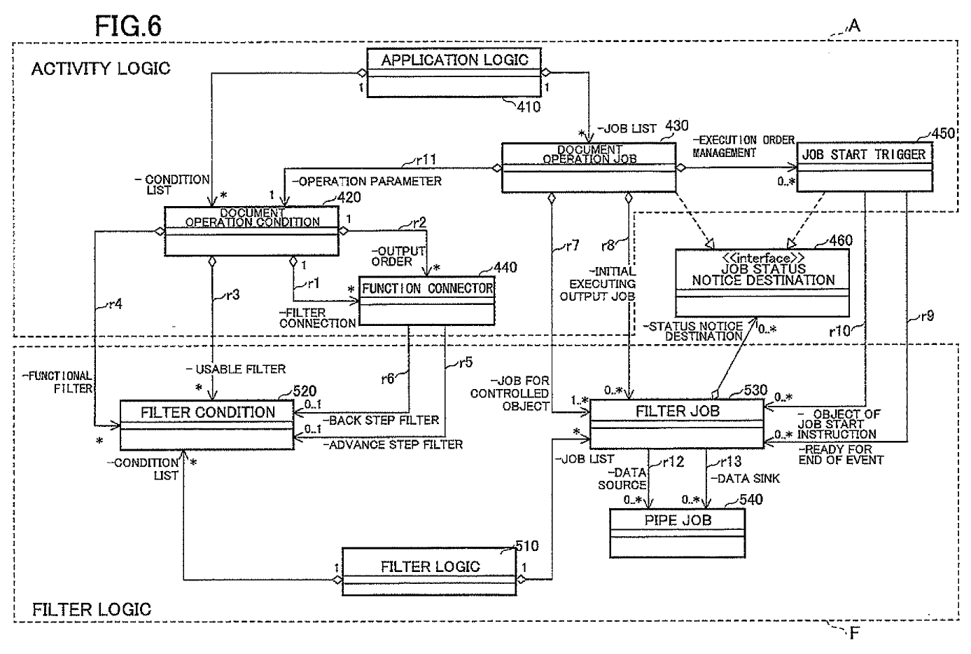

FIG. 6 is a drawing to show class components regarding document operation of the activity logic and filter logic. In this case, the document operation is an operation (process) for each item of data (e.g. image data) representing a document. Further, in the following description, “object” corresponds to instances of each class, in short, “object” is concrete data (information) generated in the memory based on the definition of the class. Therefore, information saved or managed by the object is stored in the memory. In the following description, “xxx object” corresponds to an instance of “xxx class”.

In FIG. 6, a class indicated by symbol A which is partly enclosed by a broken line, that is, an application logic class 410, a document operation condition class 420, a document operation job class 430, a function connector class 410, and a job trigger class 450, are a class group constituting the activity logic.

The application logic class 410 is an instance which expresses the activity logic of the activity 31, and manages operation condition and jobs of the activity 31. By corresponding to such management functions, the activity logic class 410 integrates the document operation condition class 420 and the document operation job class 430, respectively, by one-to-multiplicity correspondence. In this case, “job of the activity 31” is defined as a series of processes completing the functions of the activity 31, which is called specifically “document operation job” in this embodiment. For example, when the activity 31 constitutes one input filter, one converter filter and one output filter, an entire process from a start process to an end process achieved by connecting these three filters corresponds to one document operation job.

The document operation condition class 420 is one instance and corresponds to one of activities 31 that describes and manages operation condition. In short, the operation condition set by the activity 31 is saved with the document operation condition object.

A function connector class 440 plays two roles. A function connector object transformed to an instance for performing the first role manages connecting relations between filters utilized by the activity 31. A function connector object transformed to an instance for performing the second role manages an executing order (output order) of respective output filters, when the activity 31 constitutes two or more output filters (hereafter, such activity is called as “multiple outputs activity”).

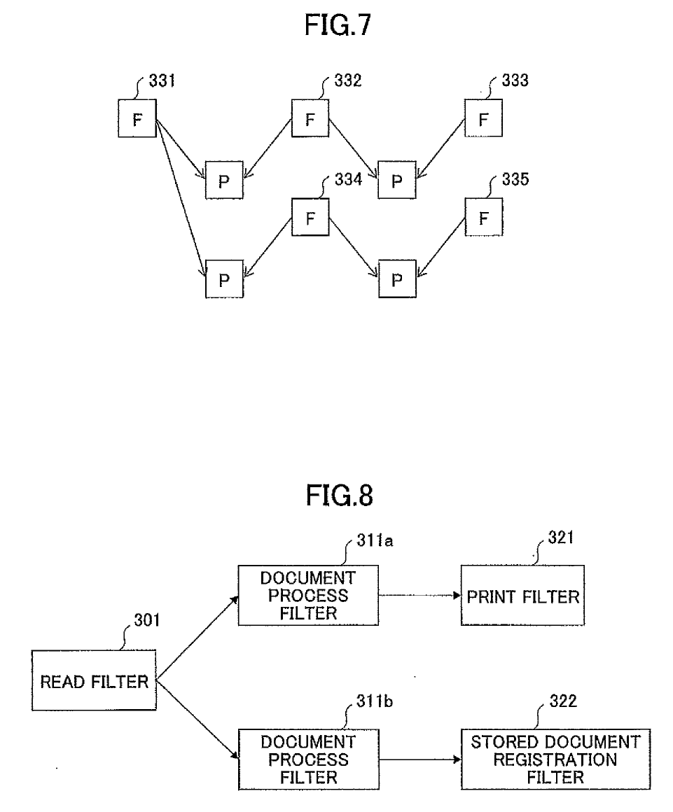

Next, the execution order (output order) of the output filters is described. FIG. 7 is a drawing to show an example of connecting relations between filters of the multiple outputs activity. In short, “F” indicates a filter and “P” indicates a pipe.

In FIG. 7, a filter 331 is an input filter. Filters 332 and 334 are converter filters, Filters 333 and 335 are output filters. In the example of FIG. 7, data input by the filter 331 is divided into two branches and becomes the filter 332 and the filter 334. The data processed by the filter 332 is output by the filter 333. Likewise, the data processed by the filter 334 is output by the filter 335. When there are plural outputs, at least plural output filters have parallel relations. In this example, an order of process (which output process is processed first or both are processed simultaneously for an output process of the filter 333 and an output process of the filter 335 is controlled. This order corresponds to the output order.

Further, in FIG. 6, the function connector class 440 is integrated to the document operation condition class 420 with a role named as “filter connection” associated to r1 and a role named as “output order” associated to r2. The association r1 indicates association with an instance that manages (i.e. plays the first role) connecting relations between filters (in FIG. 7, connections between the filter 331 and the filter 332, between the filter 332 and the filter 333, between the filter 331 and the filter 334, between the filter 334 and the filter 335) The association r2 indicates an instance that manages (i.e. plays the second role) output order.

The document job class 430 is a class controlling a document operation job. The document operation job class 430 integrates a job start trigger class 450 with one-to-multiplicity correspondence.

The job start trigger class 450 is a class that manages the output order when the output order needs to be controlled for the multiple output activity 31.

A job status notice destination class 460 is an abstract class defined by an interface for receiving a job status notice of a filter from the filter. A class required to receive a job status notice of the filter succeeds the job status notice destination class 460. In this embodiment, the document operation job class 439 and the job start trigger 450 are succeeded by the interface of the job status notice destination class 460. Further, a job of a filter is a process executed by one filter and is specifically called as “filter job” in this embodiment.

On the other hand, in FIG. 6, a class enclosed with a broken line and indicated by a symbol F, a filter logic class 510, a filter condition class 520, a filter job class 530 and a pipe job class 540 are a class group constituting filter logic.

The filter logic class 510 is a class that describes filter logic and manages operation condition and filter jobs of filters. By corresponding to such management functions, the filter logic class 510 integrates the filter condition class 520 and the filter job class 530 with one-to-multiplicity correspondence. The filter condition class 520 is a class that describes the operation condition and manages the operation condition with one instance corresponding to one filter. Therefore, the operation condition set in the filter is maintained at the filter condition class 520.

The filter job class 530 manages filter jobs.

The pipe job class 540 manages pipe jobs (transmittance of data between filters by pipes).

The filter job class 530 includes two associations (associated to r12 and r13) to the pipe job class 540 with one-to-multiplicity correspondence. The association r12 associates with a pipe job object of a pipe as “data source (data input side to the filter)”. The association r13 associates with a pipe job object of a pipe as “data sink (data output side to the filter)”.

As described above, the activity logic and the filter logic include a common part, since both are constituted by classes that mainly manage the operation condition and control the jobs. By referring to FIG. 6, associations of classes constituting the activity logic and the filter logic are described.

The document operation condition class 420 integrates the filter condition class 520 by two associations (association r3 and association r4) with one-to-multiplicity correspondence. This integrated relation indicates that the operation condition of the activity 31 is constituted by integration of the operation condition of individual filters used by the activity 31. The association r3 associates with the filter condition object of “usable filter” and the association r4 associates with the filter condition object of “functional filter”. The term “usable filter” indicates that the activity 31 statically utilizes the filter (i.e., the filter possibly being used) which can be varied for the activity 31. Therefore, the association r3 indicates that association to the filter condition object of a filter that is possibly utilized by the activity 31. The term “functional filter” indicates that the activity 31 dynamically utilizes the filter (i.e. filter actually being used). Therefore, the association r4 associates to the filter condition object that is actually used by the activity 31. Further, the “functional filter” is selected from “usable filter” according to the operation condition of the activity 31.

The function connector class 440 includes association r5 and association r6 to the filter condition class 520. The association r5 associates with filter condition object of “advance step filter” and r5 associates with filter condition object of “back step filter”. The meanings of “advance stop filter” and “back step filter” vary with roles of the function connector object. For example, when the function connector object manages connecting relations between filters, “advance step filter” indicates that the “advance step filter” is connected to locate at an advanced position in the connecting relation between filters, and “back step filter” indicates that the “back step filter” is connected to locate at a backward position in the connecting relation between filters. Also, when the function connector object manages output order, “advance step filter” indicates an output filter in which the “advance step filter” is executed in advance, and “back step filter” indicates an output filter in which the “back step filter” is executed later.

The document operation job class 430 integrates the filter job class 530 using two associations (association r7 and association r8) by one-to-multiplicity correspondence. This integrating relation indicates that the document operation job is constituted by assembly of filter jobs of individual filters used by the activity 31. The association r7 associates with a filter job object regarding a “job for controlled object”, and the association r8 associates with a filter job object regarding a “initial executing output job”. The “job for controlled object” is each filter job to be executed according to execution of a document operation job. The “initial executing output job” is an object to be instructed for starting execution the first time in response to the start of execution of the document operation job. As described later, once execution of the document operation job is started, the execution of the jobs are started in parallel to respective filters that are used by the activity 31. In a case where the output order is preset for output filters corresponding to the output filters, a start execution is instructed to the first output filter based on the output order. Therefore, the association r8 associates with the filter job object corresponding to the first output filter based on the output order. The association r8 between the document operation job class 430 and the filter job class 530 is one-to-multiplicity correspondence. Thus, the “initial executing output job” may exist for one document operation job.

The document operation job class 430 also includes association r11 for the document operation condition class 420 with one-to-multiplicity correspondence. Therefore, the document operation job object can maintain association for a corresponding document condition object.

The job start trigger class 430 includes association r9 and association r10 for the file job class 530. The association r9 associates with a folder job object 530 relating to “ready for end of event” and the association r10 associates with a folder job object 530 relating to “object of job start instruction”. When the job start trigger object 450 receives a notice of end of event of the filter job from the filter job object 530 of “ready for end of event”, the job start trigger object 450 instructs the filter object 530 of “object of job start instruction” to start a job. In other words, the filter job object of “ready for end of event” is a filter job object of an output filter executed in advance based on the output order. A filter job object of “object of job start instruction” is a file job object of an output filter to be executed later based on the output order. Namely, the output order is managed by the association r9 and the association r10. Further, the job start trigger class 450 includes association r9 and association r10 to the filter job class 530 with one-to-multiplicity correspondence. Therefore, one job start trigger object may set plural filter job objects 530 as ready for end of event, and the plural filter job objects 530 may be set as objects of job start instruction. Specifically, when the activity 31 utilizes three output filters, for example, two of the output filters may be set to wait for an end job and the other filter may be set to start executing job in response to the end of the filter job of the one filter, filter jobs of the other two filters may be started for execution.

The filter job class 530 integrates a job status notice destination. By this association, the filter job class 530 indentifies a notice destination of a change in job status (end of a job or the like). Further, as described above, the job status notice destination 460 is an abstract class in which an interface is only defined, and the document operation job class 430 and the job start trigger class 450 succeed the interface. Thus, a notice of change in the job status from the filter job object 530 is notified to the actual document operation job object 430 or the job start trigger object 450. In this case, by the job status notice destination class 460, the actual notice destination is hidden to the filter job class 530. Therefore, the filter job object 530 does not need to recognize the actual notice destination.

Further, the class diagram in FIG. 6 shows parts of frame works of the activity logic and the filter logic. Namely, respective concrete activities 31, the activity logic or the filter logic can extend their functions by succeeding the classes indicated in FIG. 6.

Based on the class diagram indicated in FIG. 6, it is described how the operation condition and the job of the copy storing function, and one of the functions of the copy activity 31 is expressed as an object. The filter including a copy accumulating function is described in advance.

FIG. 8 is a drawing to indicate an example of the filter including a copy accumulating function. As illustrated in FIG. 8, the copy accumulating function is constituted by a read filter 301, two document process filters 311 (document process filter 311a and document process filter 311b), a print filter 321, and a stored document registration filter F 322.

The read filter 301 is connected to the document process filters 311a and 311b. The document process fitter 311a is connected to the print filter 321. The document process filter 311b is connected to the stored document registration filter 322.

By connecting the read filter 301, the document filter 311a and the print filter 321, printing scanned image data, that is, a copy function can be performed. Further, by connecting the read filter 301, the document process filter 311b, and the stored document registration filter 322, a storing function storing scanned image date into a HDD (hard disk drive) can be performed. In this manner, the copy accumulating function is a plural output function utilizing two output filters that have parallel relation.

The operation condition of such a copy accumulating function is described by the following object constitution based on the class diagram of FIG. 6.

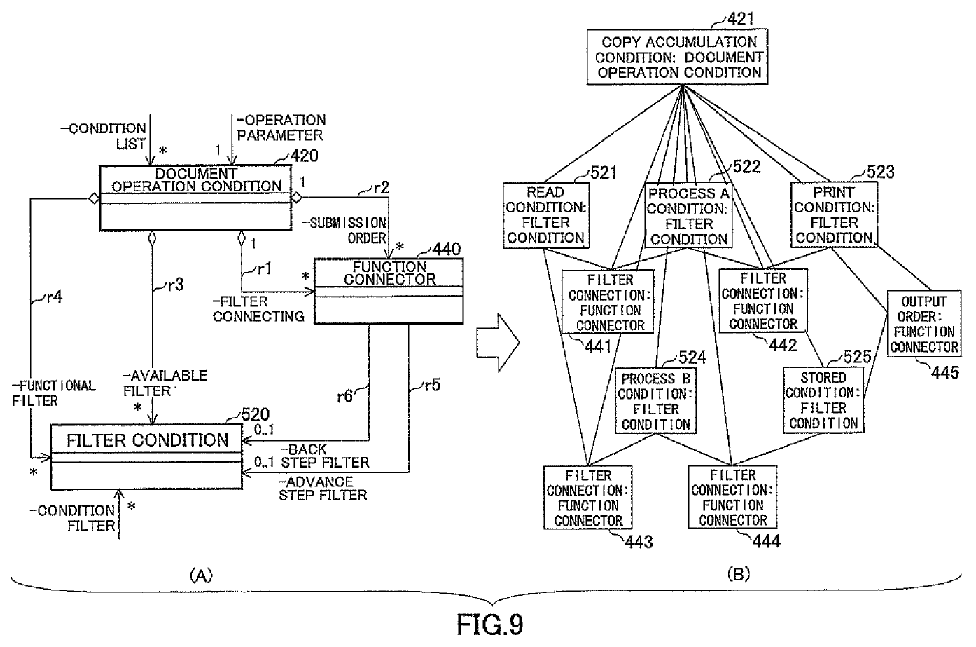

FIG. 9 is an example of an object diagram to describe the operation condition of the copy accumulating function. FIG. 9(A) is a class diagram regarding the operation condition extracted from FIG. 6. FIG. 9 (B) indicates an object diagram constituting an object transformed to instances based on the class constitution indicated in FIG. 9(A). Further, each rectangle in FIG. 9(B) indicates each object. Also, in each rectangle includes words formatted as “xxx:yyy”. In this cases “xxx” indicates a name of an object and “YYY” indicates a name of a class. In the following, when objects belong to a class is called by a general term, the general term is described as <class name>object. When each instance is specifically identified, the instance is described as <object name>object.

As shown in FIG, 9(B), the operation condition of the copy accumulating function of the copy activity 31a includes a copy accumulation condition object 421 as a document operation condition object corresponding to the copy activity 31a. Also, the operation condition of the copy accumulating function of the copy activity 31a includes a read condition object 521, a process A condition object 522, a print condition object 523, a process B condition object 524, and a stored condition object 525 as a filter condition object to correspond, respectively, to the read filter 301, the document process filter 311a, the print filter 321, the document process filter 311b, and the stored document registration filter 322. Further, as a function connector object which connects to a filter condition object corresponding to each filter in response to each connecting relation, the operation condition of the copy accumulating function of the copy activity 31a includes a filter condition object 441, a filter connection object 442, a filter connection object 443, and a filter connection object 444. Further, as a function connector object which manages the execution order between the print filter 321 and the stored document registration filter 322 based on the relation between the print condition object 523 and the stored condition object 525, the operation condition of the copy accumulating function of the copy activity 31a includes an output order object 445. Further, each connecting line indicates an association between the objects.

The object structure of FIG. 9(B) includes a tree structure with the copy accumulation condition object 421 as a root. Accordingly, in the following, the object structure describing the activity 31 is named as “condition tree”.

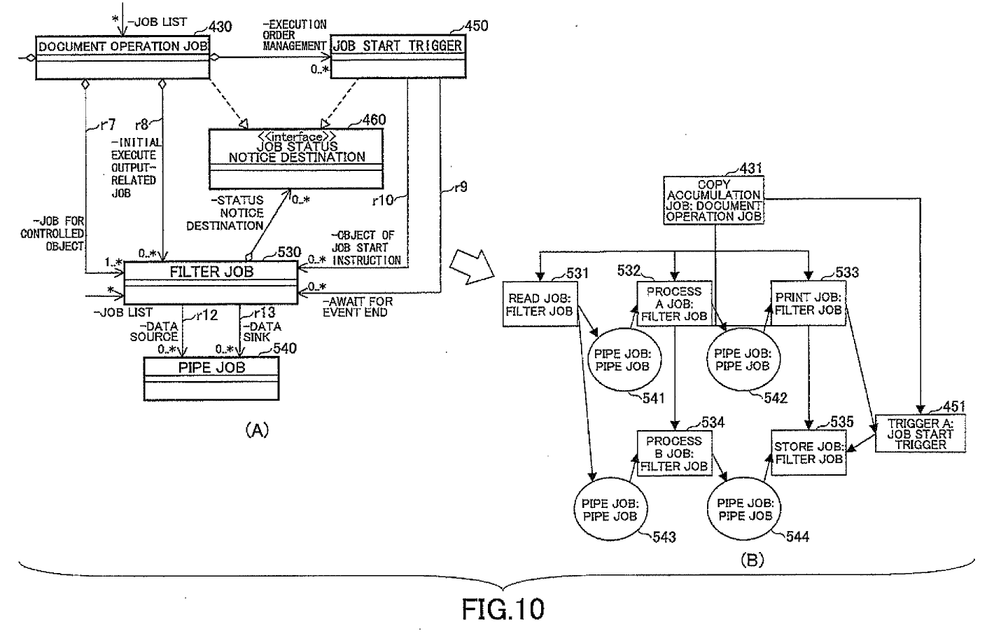

Also, FIG. 10 is an example of an object diagram describing the document operation job of the copy accumulation function. FIG. 10(A) is a class diagram relating to a job extracted from FIG. 6. FIG, 10(B) is an object diagram indicating the constitution of the object that is transformed to instances based on the class constitution indicated in FIG. 10(A).

As indicated in FIG. 10(B), the document operation job of the copy accumulation function includes a copy accumulation job object 431 as a document operation job object to correspond to the copy activity 31a. Also, as a filter job object corresponding to, respectively, the read filter 301, the document process filter 311a, the print filter 321, the document process filter 311b, and the stored document registration filter 322, the document operation job of the copy accumulation function includes a read job object 531, a process A job object 532, a print job object 533, a process B job object 534, and a store job object 535. Further, as a pipe object to correspond and connect to each filter, the document operation job of the copy accumulation function includes a pipe job object 541, a pipe job object 542, a pipe job object 543, and a pipe job object 544. Also, as a job start trigger object which manages the execution order of the print filter 321 and the stored document registration filter 322 based on the relation between the print condition object 523 and the store condition object 525, the document operation job of the copy accumulation function includes a trigger A object 451.

The object structure of FIG. 10(B) includes a tree structure with the copy accumulation job object 431 as a root. Thus, in the following, the object structure describing the activity 31 is named as “job tree”.

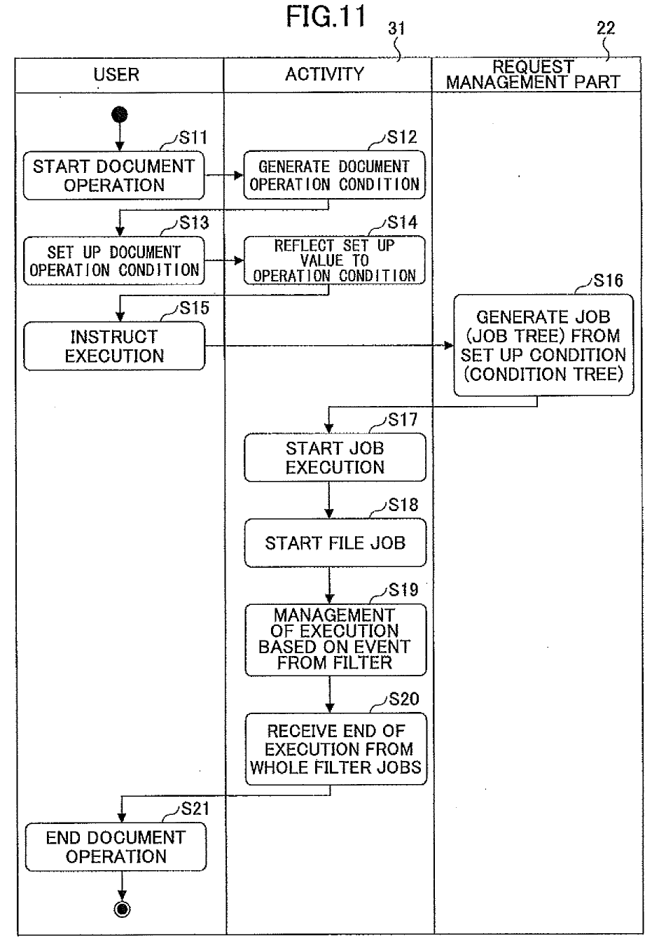

In the following, process sequences of the multi-function apparatus 1 are described based on the software described above. FIG. 11 is an activity diagram to describe a summary of execution processes of the document operation. In FIG. 11, the activity 31 is specifically referred to as the activity logic of the activity 31.

First, a start instruction of a document operation is input (S11) by a user with an operation panel of the multi-function apparatus 1. The instruction corresponds, for example, to a selection of the activity 31 which is an object to be executed. Next, the selected activity 31 (hereafter, referred as “current activity”) generates (S12) a model of a document operation condition. Specifically, the current activity generates, based on the class constitution indicated in FIG. 6, a condition tree describing the operation condition as a predetermined value of the activity 31.

Next, after the current activity is set (S13) with the operation panel by the user, the current activity reflects the set content to the condition tree (S14). Specifically, the current activity modifies the structure of the condition tree and the attribute value of each object constituting the condition tree.

For example, the modification of the condition tree is performed when a filter is newly added, when an unnecessary filter is generated, or when the output order is set for plural outputs, according to the operation condition. When a filter is newly added, a filter condition object corresponding to the filter is transferred to instances and added to the condition tree. When an unnecessary filter is generated, a filter condition object corresponding to the filter is eliminated from the condition tree. When the output order is set, a function connector object corresponding to the output order is transferred to instances and added to the condition tree.

Further, for example, changing the attribute value of each object is carried out when a filter operation condition is modified. In this case, for a filter condition object corresponding to the filter, the attribute value corresponding to the modified parameter (e.g. reading resolution for the read filter 301) is modified.

After setting the operation condition, when a document operation job is instructed to execute the current activity (S15) by pressing a start button by a user, the request management part 22 generates a job tree based on the condition tree (S16).

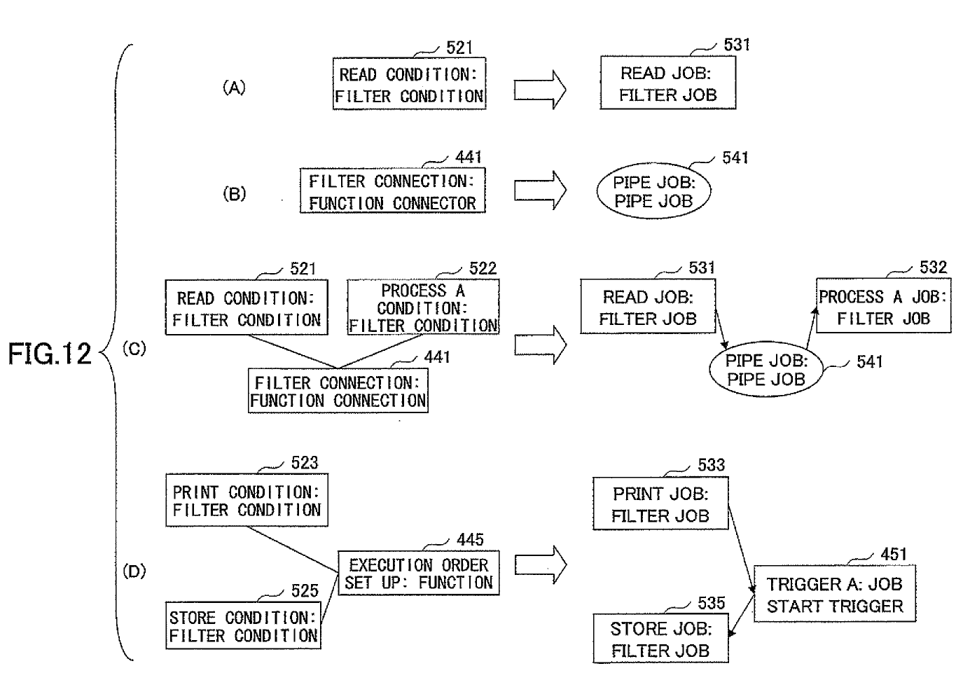

FIG. 12 is a drawing to describe a job tree generation based on the condition tree. The job tree generation is basically performed by converting each object constituting the condition tree into an object related to the job.

In short, as indicated in FIG. 12(A), a filter job object 531 is generated based on the filter condition object 521.

Further, as shown in FIG. 12(B), a pipe job object 541 is generated based on a function connector object 441 playing a role of management of filter connection.

Further, as shown in FIG. 12(C), a pipe job object 541 connects between a filter job object 31 and a filter job 532 based on a connection relation managed by the function connection object 441.

Also, as shown in FIG. 12(D), a job start trigger object 451 is generated based on the function connector object 440 playing a role of managing the output order. The filter job object corresponding to the filter connection object associated with the function connector object as “advance step filter” is associated with the job start trigger as “waiting end event”. Further, the filter job object corresponding to the filter condition object associated with the function connector object as “back step filter” is associated with the job start trigger as “job start instruction object”.

According to such a process, a job tree is generated based on the condition tree.

Next, the current activity starts executing the document operation job (S17, FIG. 11), and based on the generated job tree, starts instructing (S18, FIG. 11) execution of each the current activity which is used by the current activity. From filters having finished job execution, an end of job event is notified (S19, FIG. 11) to the current activity. After receiving the end of job event notices from all filters, the current activity ends execution of the document operation job (S20, FIG. 11). The user finishes the document operation according to the end of the document operation job (S21, FIG. 11).

The processes described with an activity diagram of FIG. 11 are expressed by using a sequence diagram specifically indicating the transmitting messages between objects by key steps.

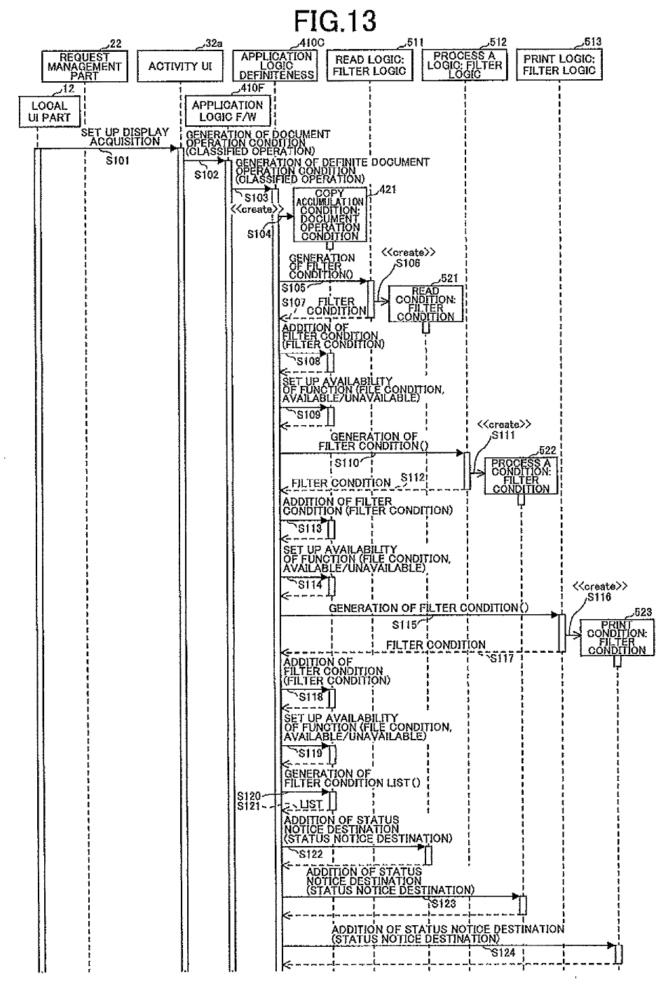

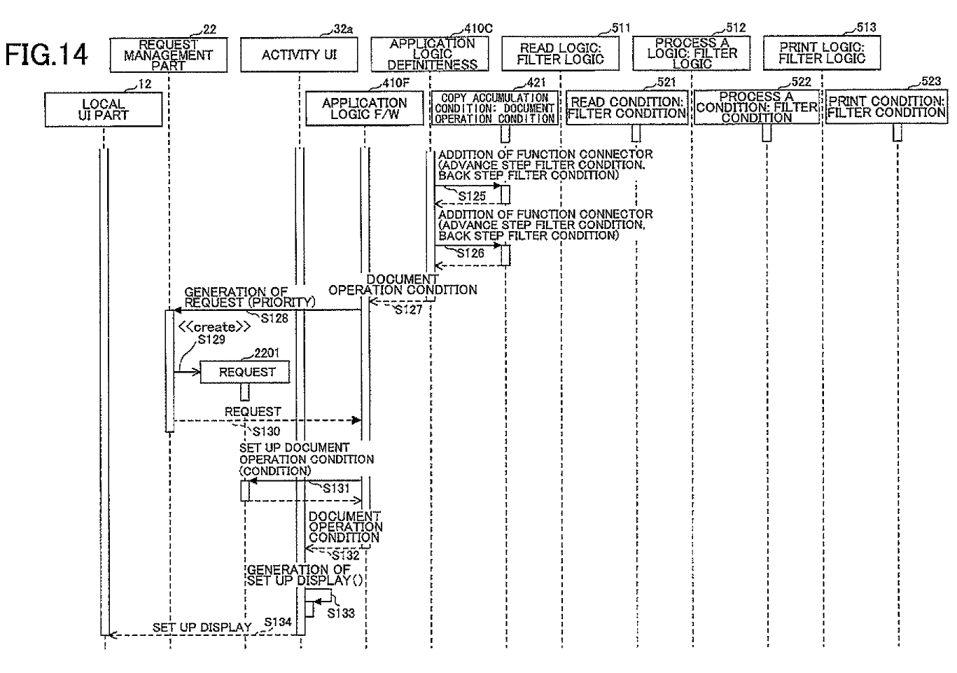

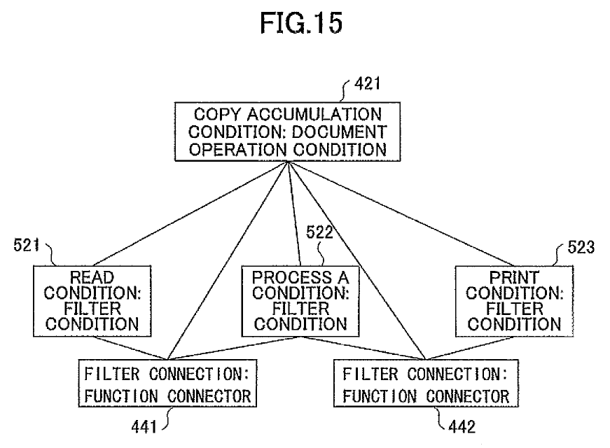

FIG. 13 and FIG. 14 are sequence diagrams to describe generation processes of condition trees. Further, the processes shown in FIG. 13 and FIG. 14 correspond to a process generating a condition tree of FIG. 15. The condition tree in FIG. 15 is part of the condition trees of a copy accumulation function shown in FIG.9.

When a user selects a copy accumulation function of the copy activity 31a with the operation panel, the local UI part 12 requests (the activity UI is described in FIG. 5) the activity UI 32a of the copy activity 31a to provide content (hereafter, “UI content”) of setting display for the copy accumulation function (3101, FIG. 13). Next, the activity UI 32a requests generating operation condition of a document operation to a frame work(F/W) part (application logic F/W 410F) of the application logic object (instance of application logic class 410) of the activity logic in the copy activity 31a (S102, FIG. 13). Next, the application logic F/W 410F requests the application logic object extension part (application logic definiteness 410) to execute generation of the specific operation condition of the copy accumulation function (S103, FIG. 13). Further, although the activity logic F/W 410F and the application logic definiteness 410C are indicated as different objects, they are actually a unit object (subclass object (extended part) of an application logic class 410 generated to be originally installed into the copy activity 31a). In short, the application logic F/W 410 indicates the installed part of the application logic class 410 as a frame work part for the object installed. Further, the application logic definiteness 410C indicates part of an installed subclass for the object installation.

The application logic definiteness 410C generates a copy accumulation condition object 421 as an instance of the document operation condition class 420 (S104, FIG. 13). Next, the application logic definiteness 410C requests the read logic object 511 (instance of the filter logic class 510) to generate an operation condition of the read filter 301 (S105, FIG. 13). The read logic object 511 generates (creates) a read condition object 521 (S106) and returns the generated read condition object 521 (or its reference information) to the application logic definiteness 410C (S107). In this case, when generating the read condition object 521, for example, the operation condition as a predetermined value of the read filter 301 is set as an attribute value of the read condition object 521 in the construction of the read condition object 521. In the next step, the application logic definiteness 410C adds the read condition object 521 to the copy accumulation object 421 as “usable filter” (S108, FIG. 13). Thereby, the association r3 (see FIG. 6) is formed between the copy accumulation condition object 421 and the read condition object 521. Next, the application logic definiteness 410C registers to the copy accumulation condition object 421 if the read condition object 521 is “functional filter (filter actually to be used)”. When the read condition object 521 is “functional filter”, association r4 (see FIG. 6) is formed between the copy accumulation condition object 421 and the read condition object 521. Further, a determination whether the read condition object 521 is “functional filter” is registered in the copy accumulation condition object 421. In the present case, the read condition object 521 is registered as “functional filter”.

Next, similar processes described in the steps S105-S109 are applied to filter logics of the document process filter 311 and the print filter 321 for steps S113-S119. Thereby, a process A condition object 522 and a print condition object 523 are generated and an association is formed between the filter condition object and the copy accumulation condition object 421.

Next, the application logic definiteness 410C obtains a filter condition object list (hereafter “filter condition list”) associated as “available filter” from the copy accumulation object 421 (S120, S121). Next, the application logic definiteness 410C establishes status notice destinations (S122-8124) for each filter condition object (read condition object 521, process A condition object 522, and print condition object 523) which is included in the filter condition list.

In the next step, the application logic definiteness 410C adds (registers) a function connector object (connection object 441 in FIG. 15) to the copy accumulation condition object 421 (S125), with setting the read condition object 521 as “advance step filter” and the process A condition object 522 as “back step filter”. Next, the application logic definiteness 410C adds (registers) the function connector object (connection object 442 in FIG. 15) with setting the process A condition object 522 as “advance step filter” and the print condition object 523 as “back step filter” to the copy accumulation condition object 421 (S126). Thereby, an association is formed between each function connector object and the copy accumulation condition object 421. In the figure, steps for modification of the function connector object into instances, registration of the filter condition object to the function connector object as “advance step filter”, and registration of the filter condition object as “back step filter” are omitted for convenience, but these processes are also performed by the application logic definiteness 410C.

According to the above description, the condition tree generation of FIG. 15 is completed. Once the condition tree is generated, the application logic definiteness 410C returns the copy accumulation condition object 421 to the application logic F/W 410F (S127, FIG. 14). Next, the application logic F/W 410F requests the request management part 22 to generate “request” as a parameter of priority (S128). In this case, the priority corresponds to priority of a document operation job regarded as an executable object, which is for example established by a user. Also, the request corresponds to information expressing an execution request of the document operation job.

The request management part 22 generates a request object 2201 (S129, FIG. 14) expressing the “request” in response to the generation request, and returns the request object 2201 to the application logic F/W 410F (S130, FIG. 14). Next, the application logic F/W 410F registers the copy accumulation condition object 421 to the request object 2201 (S131, FIG. 14). Further, the application logic F/W 410F returns the copy accumulation condition object 421 (i.e. the document operation job condition) to the activity UI 32a (S132, FIG. 14).

The activity UI 32a generates a UI content displaying the operation condition as an initial predetermined value obtained according to the condition tree based on the copy accumulation condition object 421, and returns the UI content to the local UI part 12 (S134, FIG. 14).

The local UI part displays a setting screen of the copy accumulation function on the operation panel of the multi-function apparatus 1 based on the UI content. At this stage, the operation condition (condition tree) has been generated as the predetermined value of the copy accumulation function. Therefore, after this stage, when modification is carried out for the operation condition via the setting display, the condition tree can be modified according to the modification.

Further, the rest of part of FIG. 9 may be generated by the similar processes.

Also, the condition tree constitution as a predetermined value may be directly defined (hard coding) to the application logic definiteness 410C. For example, for an editable file, the condition tree constitution may be defined with a predetermined format (e.g. XML (Extensible Markup Language) format). In the later case, as the condition tree is constructed by the application logic definiteness 410C based on the predetermined information in the file, performing a modification of the condition tree constitution as a predetermined value becomes possible without modifying source code.

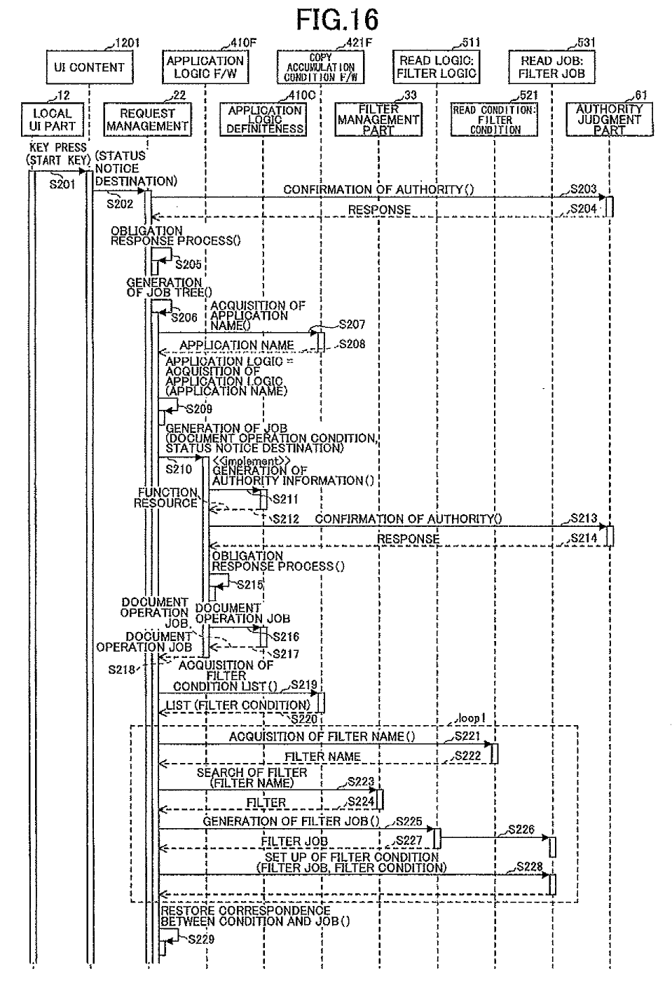

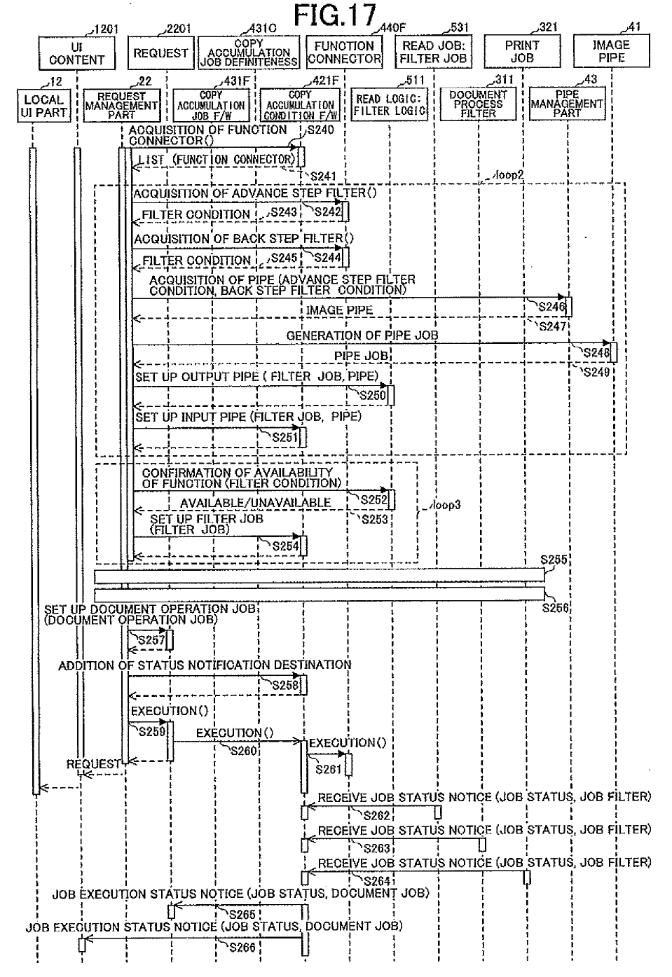

Next, processes are described where a job tree is generated based on a condition tree and a job is executed based on the job tree. FIG. 16 and FIG. 17 are sequence diagrams for describing job tree generation and a job execution process. For FIG. 16 and FIG. 17, the copy accumulation function is treated as an example for description. In FIG. 16 and FIG. 17, the identical reference symbols are used for corresponding parts in FIG. 9, FIG. 10, or FIG. 13. For convenience, in FIG. 16 and FIG. 17, the rectangular boxes used as the document process filter 311 and the print filter 321 indicate both for each filter object and each filter the job object filter.

When a start button of the operation panel on the multi-function apparatus 1 is pressed, the local UI part 12 notices the UI content 1201 about the button being pressed (S201, FIG. 16). For the UI content 1201, processes of the display parts, such as the button or the like displayed based on the UI content 1201, are defined for their operation. Therefore the UI content 1201 requests the request management part 22 to execute the document operation job of the copy accumulation function of the copy activity 31a according to the definitions (S202, FIG. 16). At this stage, the UI content 1201 is assigned as a status notice destination.

Next, the request management part 22 inquires an authority judgment part 61 about the existence of an operation authority of the copy accumulation function by a user (S203, FIG. 16). The authority judgment part 61 is software that judges the operation authority based on policy data. The authority judgment part 61 may be built in the multi-function apparatus 1 or in a computer connected to the multi-function apparatus 1 via a network (e.g. a security server). When a judgment result (S204) returned by the authority judgment part 61 indicates approval of the authority, the succeeding process is continued.

Next, the request management part 22 executes obligation process assigned based on the judgment result of the authority judgment part 61 (S205, FIG. 16). In this case, the obligation is condition received after the approval of the authority. For example, a recording log or the like is a typical case. Next, the request management part 22 starts generating a job tree (S206). Steps S207-S254 are related to the job tree generation.

First, the request management part 22 obtains an application name of the copy accumulation function from the copy accumulation condition F/W 421F, which is part of a framework of the copy accumulation condition object 421 and is registered on a request object 2201 (S207, S208, FIG. 16). The application name identifies a function of each activity 31. Next, based on the application name, the request management part 22 obtains an application logic object corresponding to the copy accumulation function (S209). Further, the application logic object corresponding to each activity 31 is managed with a memory area which is available to the request management part 22 for accessing.

Next, the request management part 22 requests (S210) the obtained copy accumulation condition F/W 410F of the application logic object to generate a job (job tree). The application logic F/W 410F requests (S211) the application logic definiteness 410C to generate authority information (information on function and resource for use) according to the established operation condition (condition tree). The application logic definiteness 410C generates authority information and returns the authority information to the application logic F/W 410F (S212).

Next, the application logic F/W 410F inquires the authority judgment part 61 about existence of authority according to the operation condition based on the authority information (S213). When a judgment result of the authority is returned from the authority judgment part 61 (S214), the application logic F/W 410F executes process related to the obligation assigned with the judgment result (S215). The application logic F/W 410F requests the application logic definiteness 410C to generate a document operation job object corresponding to the copy accumulation function (S216). The application logic definiteness 410C generates the copy accumulation job object 431 as the document operation object corresponding to the copy accumulation function, and returns the copy accumulation job object 431 to the application logic F/W 410F (S217). In this case, the copy accumulation object 431 is an instance of a subclass succeeding the document operation job class 430 which is part of the framework. In FIG. 17, the copy accumulation job F/W 431F indicates an installed part of the document operation job class 430 of the framework part for installation of the copy accumulation job object 431. Also, the copy accumulation job definiteness 431C corresponds to installed part of a subclass for the installation of the copy accumulation job object 431.

Next, the application logic F/W 410F returns the generated copy accumulation job object 431 to the request management part 22 (S218). At this stage, only the root job part of the job tree is generated.

Next, the request management part 22 requests the copy accumulation condition F/W 421F to acquire a filter condition object list (filter condition list) (S219). For condition tree, the copy accumulation condition F/W 421F returns the filter condition object list associated with the copy accumulation condition object 421 (S220).

The request management part 22 determines one of the filter condition objects included in the filter condition list as an object to be processed (the read condition object 521 is set as an object to be processed in this case), and obtains a filter name from the read condition object 521 (S221, S222, FIG. 16). The filter name is for identifying each filter. Next, the request management part 22 requests (S223) the filter management part 33 to search a filter (more specifically, a filter logic object) based on the obtained file name. The filter management part 33 searches the filter having a name corresponding to the filter name being searched from the managing filter list and returns (S224) the filter object of the filter (the read logic object 511, in this case) to the request management part 22. Next, the request management part 22 requests (S225) the read object 511 to generate a filter job object of the filter (the read filter 301). The read logic object 511 generates (S226) the read job object 531 and returns (S227) the read job object 531 to the request management part 22. In this case, the steps S221-S226 processes to achieve the process indicated in FIG. 12(A).

Next, the request management part 22 registers the corresponding filter condition object (read condition object 521) to the read job object 531. The request management part 22 records (save) the read condition object 521 and the information (correspondence information) indicating corresponding relation between the read job object 531 generated in response to the read condition object 521 in a recording device (S229).

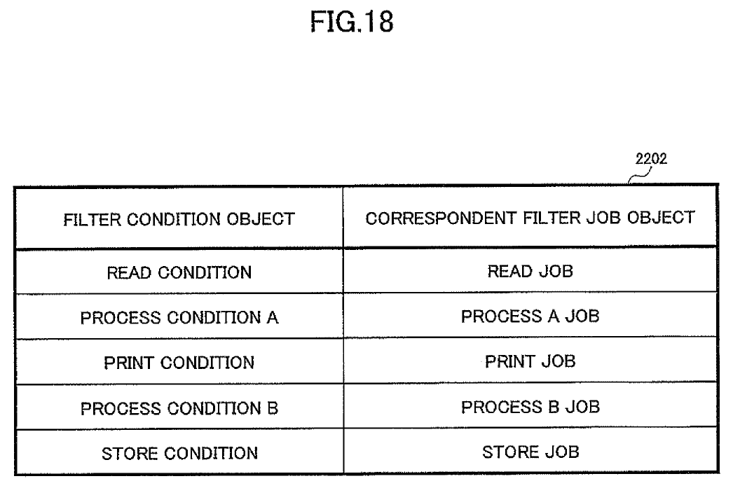

The steps S221-S239 are performed (loop 1) for each filter condition object (i.e. each filter condition object constituting the condition tree) included in the obtained filter condition list at the step S220. As a result, each filter job object (e.g. the process A job object 532, the print job object 533 or the like omitted in FIG. 16) constituting the job tree is generated and registered to each corresponding filter logic object. Further, by the step S229, information indicated in FIG. 18 is recorded in the memory device.

FIG. 18 indicates correspondence relation between the filter condition object and the filter job object. For correspondence information 2202 indicated in FIG. 18, filter condition object corresponding to each filter job object is expressed by a table format. For an example in FIG. 18, the read job object 531 corresponds to the read condition object 521, the process A job object 532 corresponding to the process A condition object 522, the print job object 533 corresponds to the print condition object 523, the process B job object 533 corresponds to the process B condition object 524, and the store job object 535 corresponds to the store condition object 525.

The correspondence relation 2202, for example, specifically, may be constituted by holding the correspondence relation between the reference information (pointer information or the like) of each object and the identification information (ID or the like).

In the following, when “correspondence” is used in the relation between the filter condition object and the filter job object, the correspondence relation indicates correspondence relation identified based on the correspondence information 2202. Thus, when mentioning that file job object “corresponds” to filter condition object, the filter job object is regarded as being generated based on the filter condition object, that is, the filter job object is related to an identical filter that is related to that filter condition object.

Next, the request management part 22 requests the copy accumulation condition F/W 421F to obtain the function connector object list (FIG. 17, S240). The copy accumulation condition F/W 421F returns the function connector object list (function connector list) associated with the copy accumulation condition object 421 in the job tree (S241).

Next, the request management part 22 requests (S242) the current function connector object to obtain a “advance step filter”, in which one of the function connector objects 440F included in the function connector list is supposed to be an object being processed. The current function connector object returns (S243) a filter condition object associated with the current function connector object itself as “advance step filter”. Next, the request management part 22 requests (S244) the current function connector object to obtain a “back step filter”. The current function connector object returns (S245) a filter condition object associated with current function connector object itself as “back step filter”. For example, when the current function object is the filter connector object 441 (see FIG. 9 or FIG. 15), the read condition filter 521 as “advance step filter” is obtained by the process A condition object 522 as “back step filter”.

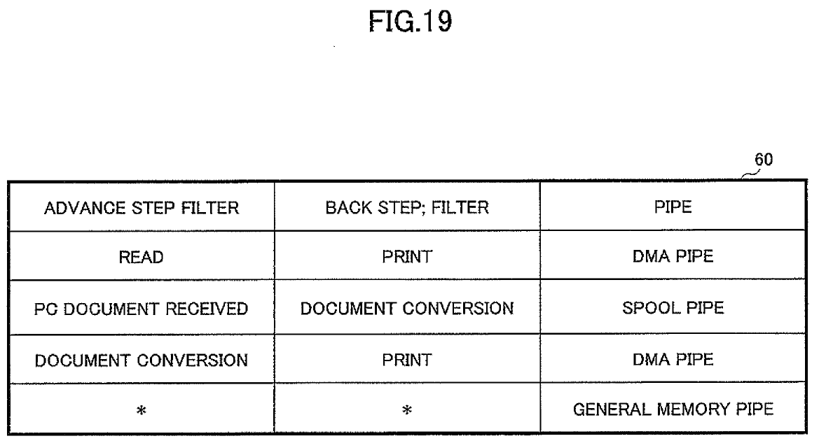

Next, the request management part 22 requests (S246) the pipe management part 43 to obtain a pipe corresponding to the combination designating the filter condition object related to “advance step filter” and the filter condition object related to “back step filter”. The pipe management part 43 determines a corresponding pipe based on the designated combination “advance step filter” and “back step filter”. In short, the entity of the pipe is a memory (including HDD (Hard Disk Drive)), but the used memory type is varied in accordance with filters at both ends of the pipe. The correspondence relation is, for example, defined in the HDD of the multi-function apparatus 1 as shown in FIG. 19.

FIG. 19 shows a table corresponding to filters and pipes. In the correspondence table 60 shown in FIG. 19, pipes based on combinations of “advance step filter” and “back step filter” is defined. For example, the read filter 301 and the print filter 321, the document converter filter 312 and the print filter 321, are connected with a DMA (Direct Memory Access) pipe and the data are transferred at high speed. Further, the PC document receiver filter 305 and the document converter filter 312 are connected with a spool pipe. The spool pipe uses a HDD, and data output from the left side filter is spooled (stored) with the HDD until the right side filter read out the data. The rest of the filters are connected with conventional memory pipes. The conventional memory pipe transmits data by using RAM (Random Access Memory) buffers having finite size. The correspondence table of FIG. 19 may be edited according to an extension (addition) of filters and pipes or a deletion or the like. Further, the image pipe 41 of FIG. 1 abstractly expresses modules providing interfaces to each pipe described above.

Thus, the pipe management part 43 determines a pipe to connect any identified two filters based on the correspondence table 60, and returns the image pipe 41 corresponding to the pipe to the request management part 22 (S247).

Next, the request management part 22 requests (S248, FIG. 17) the returned image pipe 41 to generate a pipe job object for managing jobs of the image pipe 41, the image pipe 41 generates a pipe job object and returns to the request management part 22 (S249, FIG. 17).

Further, the request management part 22 indentifies a filter job object (read job object 531) of “advance step filter” and the pipe job object, and requests (S250, FIG. 17) the filter logic object (here, the read logic object 511) of “advance step filter” to register the pipe job object as an output side pipe (as “data sink”). In response to the request, the read logic object 511 associates the pipe job object with the read job object 531 as “data sink”. Thereby, the association r13 is formed between the read job object 531 and the pipe object (see FIG. 6).

Next, the request management part 22 indentifies the filter job object (the process A job object 531) of “back step filter” and the pipe job object and requests (S251, FIG. 17) the filter logic object (the process A logic object 512, here) of “back step filter” to register the pipe job object for the filter job object as an input side pipe (as “data source”).

Further, the steps S242-S251 are executed (loop2) for each function connector object (i.e. each function connector object constituting the condition tree) in the step S241. As a result, the association r12 and the association r13 are formed between each filter job object and each pipe job object (i.e. each filter job object is connected with the proper pipe object).

Next, the request management part 22 indentifies one filter condition object (e.g. the read condition object 521) included in the filter condition list, and inquires of the filter logic object (e.g. the read logic object 511) corresponding to the filter condition object whether the filter condition object is effective (S252, FIG. 17). The filter logic object determines the filter condition object to be effective when the identified filter condition object is associated with the document operation object as “functional filter”, and the filter logic object determines the filter condition object to be ineffective when the identified filter condition object is not associated, and then returns the judgment result to the request management part 22 (S253, FIG. 17).

The request management part 22 registers the filter job object (e.g. the read job object 531 when the filter condition object is the read job condition object 521) corresponding to the filter condition object on the copy accumulation job F/W 431F (S254, FIG. 17).

Further, the steps S252-S254 are executed for each filter included in the filter condition list (loop 3, FIG. 17). Consequently, the association r7 is formed between the filter job object and the copy accumulation job object 431 corresponding to the effective filter condition object.

When the function of the activity 31 regarded as an object to be processed has multiple outputs, the setting for the output order is reflected to the job tree (S255, FIG. 17) by control of the request management part 22. Next, an initial execution job (filter job to be set as an object to be instructed as initial start execution in response to the start of execution of the document operation job) is selected (S256, FIG. 17) from the output related jobs (a filter job of an output filter) by the request management part 22. Steps S255 and S256 will be described later.

At this stage, the job tree formation is completed.

Next, the request management part 22 registers (S257, FIG. 17) the document operation job object (copy accumulation job object 431) corresponding to a root of the generated job tree for the request object 2201. Next, the request management part 22 registers the job status notice destination with the copy accumulation job F/W 431F (S258, FIG. 17). At this stage, the request object 2201 is registered as the job state notice destination.

Further, the request management part 22 instructs the job registered with the request object 2201 (S259, FIG. 17) to execute. The request object 2201 requests the copy accumulation job F/W 431F of the registered copy accumulation job object 431 to execute a job (S260, FIG. 17). The copy accumulation job F/W 431F requests the copy accumulation definiteness 431C to execute a job (S261). At this stage, the copy accumulation definiteness 431C requests each filter job object constituting the job tree to execute a job, which will be described later.

After that stage, when each job for each filter is completed, job completion is notified (S262, S263, S264) to the copy accumulation job F/W 431F by each filter job object of each filter. When the job completion is noticed from all filter job objects having been requested to execute filter jobs, the copy accumulation job F/W 431F notices respectively the request object 2201 and the UI content 1201 of the completion of the document operation job (S265, S266). In response to the notice, for example, the UI content 1201 displays a screen indicating that the document operation job has been completed.

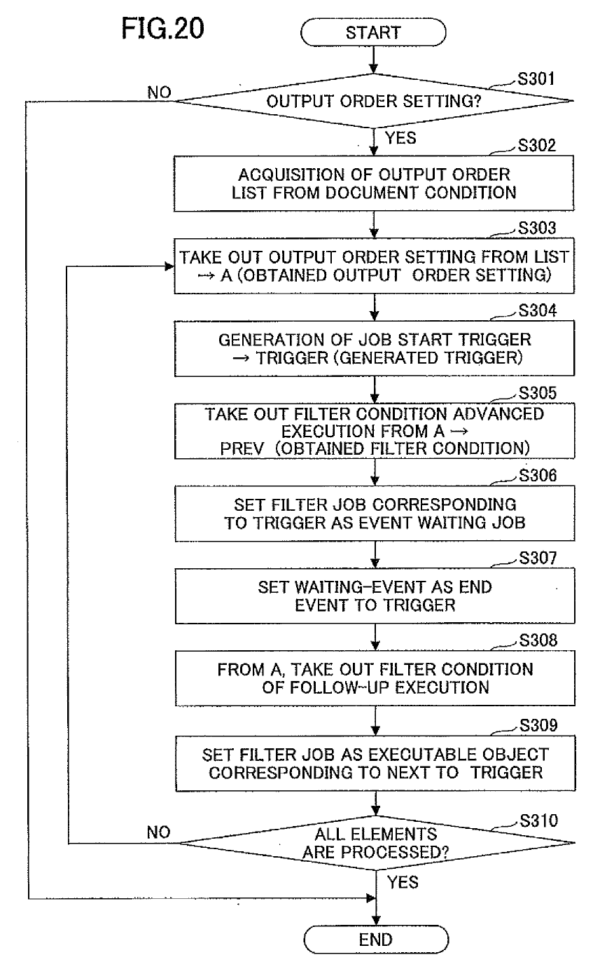

Further, a process executed at the step S255 in FIG. 17 is described in detail. FIG. 20 is a flowchart to describe the setting process of an output order to the job tree for the request management part having plural outputs.

At step S301, a presence of output order setting is determined with reference to the condition tree. For the condition tree, when even one function connector object managing “output order” (i.e. association r2, see FIG. 6, related to the function connector object; in FIG. 9, the output order object 445 is corresponded) exists, it is determined that the output order setting exists. When the function connector object does not exist, it is determined that the output order setting does not exist.

When there is a presence of the output order setting (YES at S301), the function connector object list (hereafter “output order setting list”) managing “output order” is obtained from the condition tree (S302). Next, one function connector object (output order setting) is taken out from the output order list (S303). Hereafter, the taken function connector object is named as “current function connector object”. Next, a job start trigger object is generated (S304) corresponding to the current function connector object. The generated job start trigger object is named as “current job start trigger object”, hereafter.

Next, a filter condition object (hereafter “advance filter condition object”) associated as “advance step filter” to the current function connector object is obtained from the current function connector object(S305). Next, a filter job object corresponding to the advance step filter condition object is associated with the current job start trigger as an event waiting object (S306), and the event waiting object is set with the current job start trigger object as an end event (S307). Thereby, the association r9 (see FIG. 6) is formed between the current job start trigger and the filter job object.

Further, a filter condition object (hereafter “back step condition object”) associated as “back step filter” with the current function connector object is obtained from the current function connector object (S308). Next, the filter job object corresponding to the back step filter condition object is associated as “job start instruction object” (S309). Thereby, the association r10 is established between the current job start trigger and the filter job object (see FIG. 6).

Processing steps S304-S309 are to achieve the content process described in FIG. 12(D). Also, the job start trigger object may be associated with the filter object as “waiting end event” and the filter job object as “job start instruction object” in plural.

When the process steps S303-S309 are executed (YES at S310) for all connector objects included in the output order setting list, the process in FIG. 20 is completed. Further, at step S301, if the output order is determined to be not existing (NO at S301), the rest of the steps following S302 are not executed.

Next, processes to be executed at step S256 of FIG. 17 are described in detail below. FIG, 21 is a flowchart to describe selecting a process of filter jobs related to output initially executed by the request management part.

At step S351, referring to the condition tree, a presence of the output order setting is determined. This process is similar to step S301 of FIG. 20. When the output order setting exists (YES at S351), the function connector object list managing “output order” is obtained from the condition tree (S352). Next, one function connector object (output order setting) is taken out from the output order setting list (S353). Hereafter, the function connector object taken out is named as “current function connector object”. Next, the filter condition object (hereafter, “back step filter condition object”)) associated with the current function connector object as “back step filter” is obtained from the current function connector object (8354), and followed by adding the back step filter condition object to an exception list (S355).

The exception list is to hold the filter condition object regarding the output filter excluded from an initial executable object for a process described later. The multi-function apparatus 1 of this embodiment, a follow-up filter carried out later in the output order cannot be the initial executable object. Thus, the back step filter condition object is registered in the exception list.

When steps S303-S309 are executed (YES at S356) for entire function connector objects included in the output order setting list, the process is advanced to step S375.

Also, at step S351, when there is no presence of the output order setting (NO at S351), steps S352-S356 are not executed and the process advances to step S357.

Following step S357, the entire filter condition objects of the output filter are searched in the filter condition object constituting the condition tree, and by eliminating filter condition objects included in the exception list from the searched filter condition object, an initial executable output filter job is identified.

At step S357, a list (hereafter, “filter connector information list”) of the function connector object (i.e. the function connector object related to the association r1 (see FIG. 6), corresponding to filter connector objects 441-444 in FIG. 9) managing the “filter connector” is obtained from the condition tree. Next, one of function connector objects (filter connector information) is taken out from the filter connector information list (S358). Hereafter, the taken function connector object is named as “function connector object A”. Next, a filter condition object (hereafter, “A back step filter condition object”) associated with the function connector object A as “back step filter” is obtained from the function connector object A (S359).

Next, by replacing FALSE into a flag variable (FOUND variable) used for searching filter job objects of the output filter, initialization is performed (S360). Next, a function connector object following the function connector object A is taken out from the filter connector information list. Hereafter, the taken out function connector object is named as “function connector object B”. In the next step, the filter condition object (hereafter, “B advance step filter condition object”) associated with the function connector object B as “advance step filter” is obtained from the function connector object B (S362).

Next, it is determined if the A back step object and the B advance step object are identical (S363). When two are identical, as the A back step object is not the filter condition object of the output filter, TRUE is input as FOUND variable (S364), and the process advances to step S367. On the other hand, when the A back step object and the B advance step object are not identical, it is determined (S365) whether there is a presence of a function connector object (unexecuted function connector object) not regarded as an executable object for the function connector object B, which is not the function connector object A in the filter connector information list. When an unexecuted function connector object exists (NO at S365), the process returns to step S360. If an unexecuted function connector object does not exist (YES at S365), the process advances to step S367.

For advancing to step S367, if the A back step object and the identical B advance object exist, the FOUND variable becomes TRUE, and if the A back step object and the identical B advance object does not exist, the FOUND variable becomes FALSE. The FOUND value being TRUE indicates that A back step object is not the filter condition object of the output filter. In contrast, the FOUND value being FALSE indicates that A back step object is the filter condition object of the output filter.

The step described above is described using the condition tree of FIG. 9(B). For the condition tree, the print condition object 523 and the store condition object 525 correspond to the filter condition objects of the output filter. The two filter condition objects include a function connector object which establishes the object to “back step filter”, but does not include a function connector object that establishes the object to “advance step filter”. On the other hand, the filter condition objects without the output filter include a function connector object which establishes the object to “advance step filter” and also include a function connector object which establishes the object to “back step filter”. For steps S360-S365, based on such manner of the condition tree, it is determined whether the A back step object is the function connector object of the output filter. Therefore, when FOUND value shows FALSE, it can be determined that the A back step object is the filter condition object of the output filter.

Next, at step S367, the FOUND variable is determined if the value is TRUE (i.e. if the A back step object is the filter condition object of the output filter). If the FOUND variable value is not TRUE (the A back step object is the filter condition object of the output filter) (YES at S367), it is determined whether the A back step object is included in the exception list (S368). IF the A back step object is not included in the exception list (YES at S368), the filter job object corresponding to the A back step object is to be associated with the document operation job object (e.g. the copy accumulation job object 431 in FIG. 10) of the job tree as “initially executable output related job” (S369). Thereby, the association r8 (see FIG. 6) is established between the document operation object and the filter job object of the output filter.

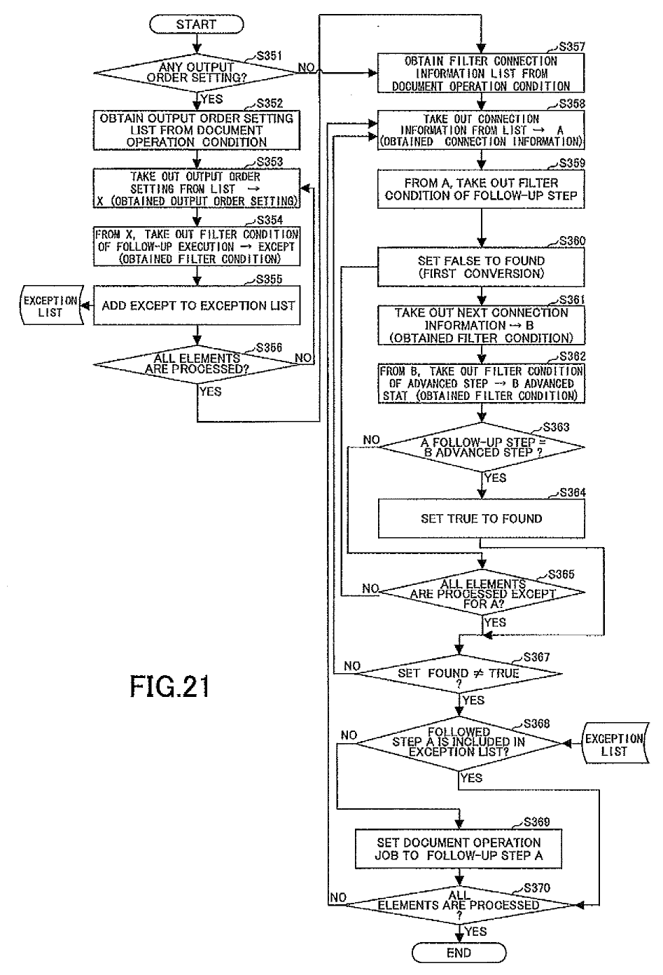

When the entire function connector objects included in the filter connector information list are executed as the function connector object A (YES at S370), the process of FIG. 21 is completed. Further, the one document operation job object is associated with plural filter job objects as “initial executable output related job”.

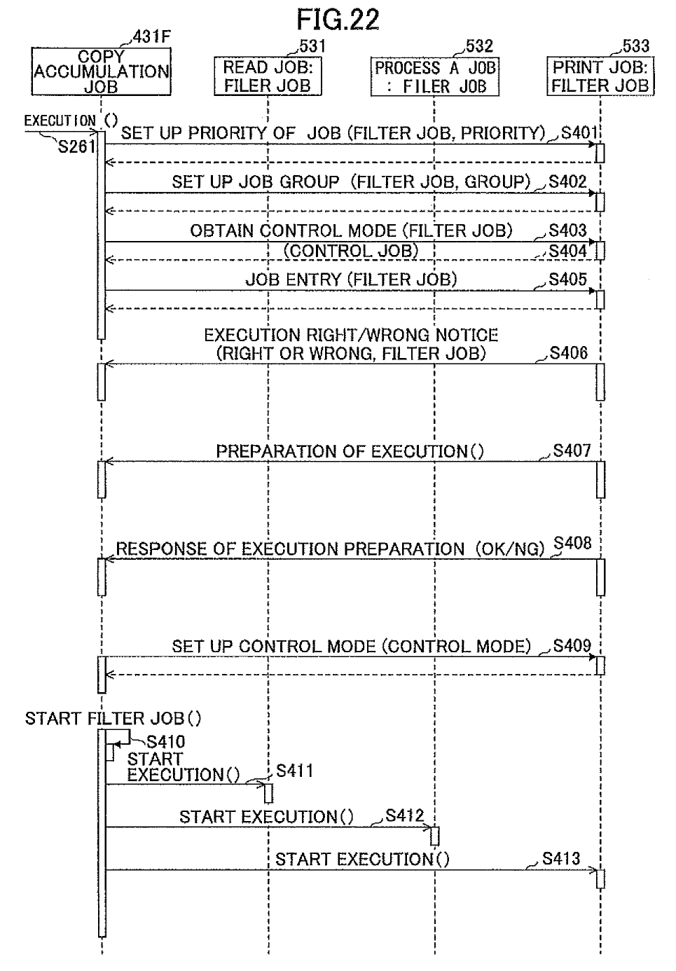

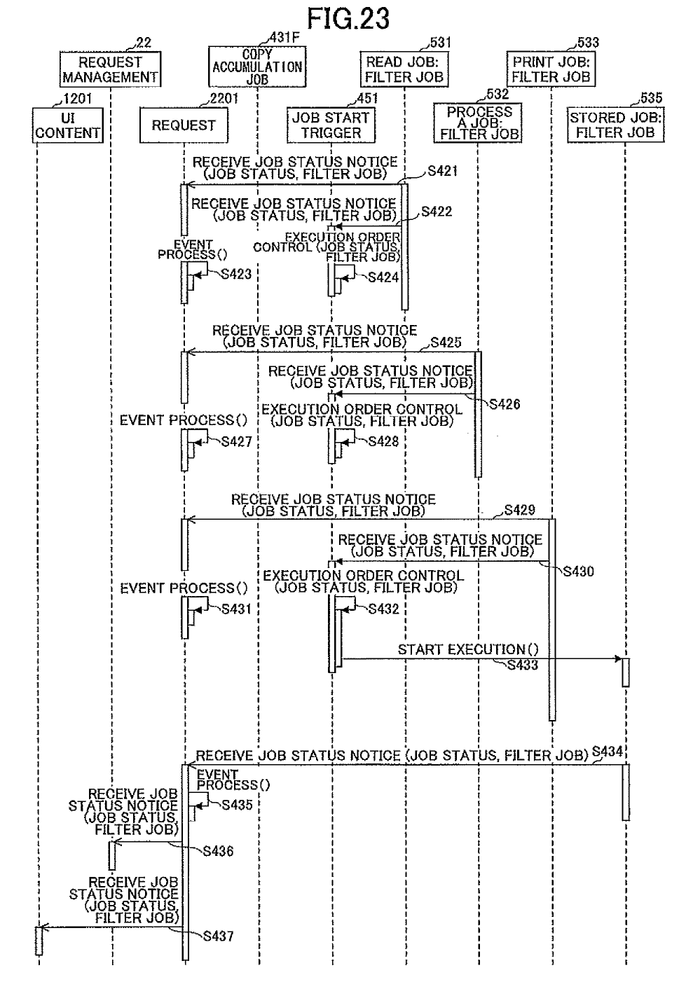

Next, processes being executed in response to the execution request of job at step S261 of FIG. 17 are described. FIG. 22 and FIG. 23 are sequence diagrams to describe execution processes of filter jobs. In FIG. 22 and FIG. 23, the same reference symbols are used for identical parts which are indicated in FIG. 16, FIG. 17, FIG. 9, and FIG. 10.

After receiving a job execution request(S261), the copy accumulation job F/W 431F performs setting a job priority (S401), setting a job group (S402), acquiring control mode (S403, S404), setting of a job entry (S405) to each filter job object (i.e. filter job object having association R7 (see FIG. 6) with the copy accumulation object 431) constituting the job tree. The control mode is information that indicates whether another filter job needs to be synchronized and is executable in parallel. The setting job entry establishes the job under control of a schedule.

Each filter job object notices (S406) the copy accumulation job F/W 431F if the filter is executable (executable notice). If all notices received from each filter job objects are executable, the copy accumulation job F/W 431F requests each filter object to prepare execution of a job (S407). Each filter object prepares execution of holding resources or the like, and sends the feasibility of executing the job (S408) to the copy accumulation job F/W 431W. Once preparation for execution becomes successful for all of filter job objects, the copy accumulation job F/W 431F establishes control mode for each filter job object (S409). The control mode to be set indicates a result that the copy accumulation job F/W 431F has adjusted to maintain consistency of each filter job based on control modes received from each filter job object.

Further, in the figure, although steps S401-S409 are indicated to execute only the read job object 531, the steps are performed to each filter job constituting the job tree, as described above.

Next, the copy accumulation job FE/W 431F starts executing the document operation job of the copy accumulation function (S410). Namely, the copy accumulation job F/W 431F instructs starting execution of each filter job to each filter job object (S411, S412, S413). In this stage, the instruction of starting execution is performed to each filter job object in parallel without waiting completion of previous executing filters for connecting relation between filters, having no relation with input filters, converter filters, and output filters. Further, regarding the filter job object of the output filter, only a job registered as an “initial executable output related job” for the copy accumulation job object 431 (having association r8 (see FIG. 6)) becomes an instruction object of execution start. Thus, for example, in FIG. 9, the store job object 535 has not received the instruction of starting job execution at this stage. Further, when there are plural filter job objects registered as “initial executable output related job”, the plural filter job objects become objects receiving instruction of start execution.

The filter job object receiving execution starts instruction controls execution of the filter job. When a synchronized mode (a mode starts execution job after the previous filter's execution is completed) is established as a control mode, the filter waits until data is input in the input side pipe of that filter. In this case, when the previous filter outputs image data as execution result of the job, the filter starts executing its own job. In short, the synchronizing between filters is performed by a pipe. Further, there is no pipe for an input filter at input side. Then the input filter starts a process in response to the execution start instruction.

Next, if the job status changes, each filter job object sends a notice of events indicating the job state after the change (job completion or job interruption) to the copy accumulation job F/W 431F and the job start trigger object 451 that are associated as “job state notice destination” (FIG. 23, S421, S422, S425, S426, S429, S430).

The copy accumulation job F/W 431F performs a process according to the notice sent form each filter job object (S423, S427, S431). Also, the job start trigger object 451 performs a process according to the content of the noticed event (S424, S428, S432). Particularly, for the activity 31 (function) regarded as an execution object to perform plural outputs, the job start trigger object 451 instructs (S433) the filter job object (i.e. a filter job object of the output filter to be executed later; for the copy accumulation function, the store job object 535 is corresponded) associated by the association r10 (see FIG. 6) as “job start instruction object” to start executing a job, when receiving an end event notice from the filter job object (i.e. a filter job object of the output filter to be executed in advance; for the copy accumulation function, the print job object 533 is corresponded) associated by the association r9 (see FIG. 6) as “waiting end event”.

In this manner, for output filters excluded from objects as “initial executable output related job”, the job execution start is instructed by the job start trigger object 450 in response to the end of executing filter job of the output filter regarded as being performed in advance. Thereby, the output order is properly controlled for a plural output case. For this embodiment of the copy accumulation function, data generated by the store document registration filter 322 is saved after finishing print by the print filter 321.

For filter job objects that are not “initial execution output related job”, only an instruction source is different from another filter job object and procedures after starting the job execution are similar to the other job object filter. Therefore, when the job state is changed, the event indicating job state after changing is notified to the copy accumulation job F/W 431F associated as “start notice destination” (S434). The copy accumulation job F/W 431F executes a process in response to the content of event notice from the filter job object (S435).

After notice of the end of event from all filter job objects, the copy accumulation job F/W 431F notifies the request object 2201 and the UI content 1201 about the end of the document operation job of the copy accumulation function (S436, S437).

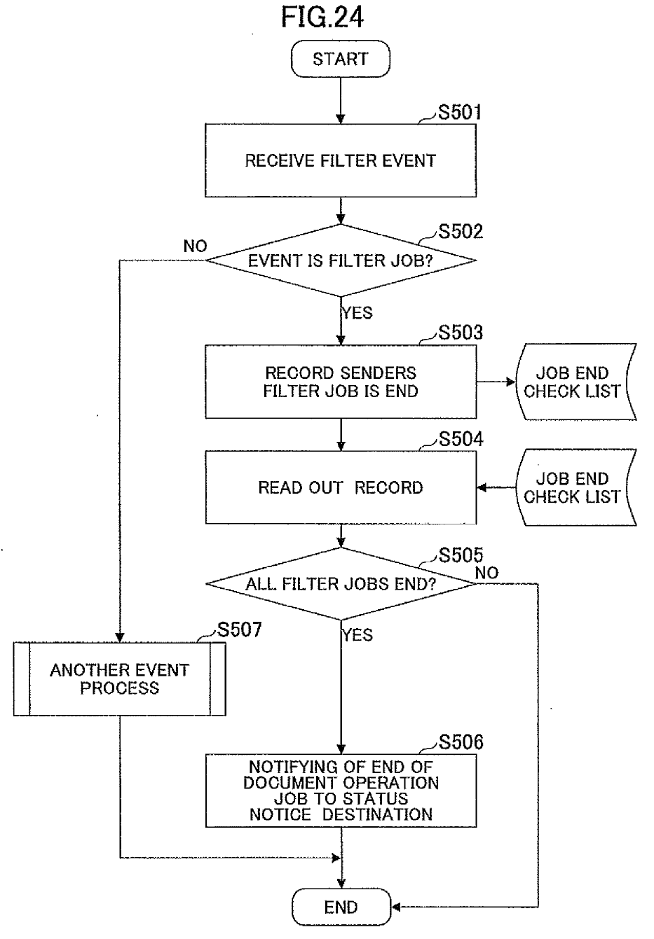

Next, at steps S423, S4271 S431, and 8435 in FIG. 23, processes performed by the copy accumulation job F/W 431F are described. FIG. 24 is a flowchart to describe the process sequence of event processes by the document operation job object.

At step S501, an event is received from the filter job object. Next, it is determined whether the event is an end event of the filter job (S502). If the event is the end event (YES at S502), that the filter job of the filter object of the event sender has been finished is additionally recorded (end of job record) on the job end check list on the memory device (S503). Next, the end record of all filter jobs recorded on the job end check list is read (S504), and it is determined whether the job (filter job) of all filter job objects constituting the job tree is finished (S505). If all filter jobs are finished (YES at S505), completion of the document operation job is notified (S506) to the state notification destination (in FIG. 23, corresponding to the request object 2201 and the UI content 1201). If all filter jobs are not finished (NO at S505), the document operation job is not finished and the process of FIG. 24 is finished. Further, if the received event is not an end event, (NO at S502), a proper process corresponding to the event is executed (S507).

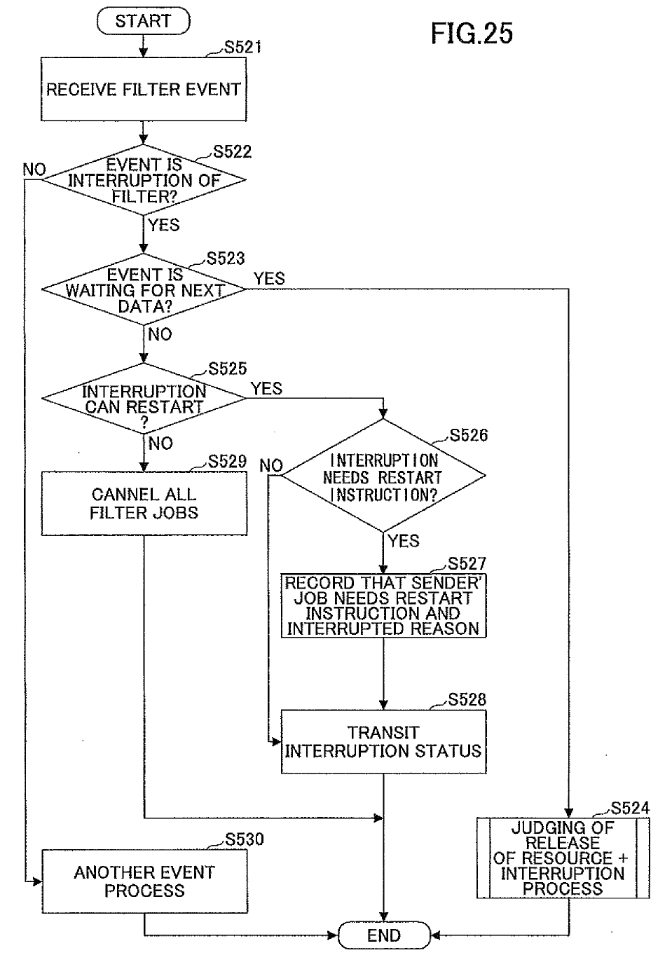

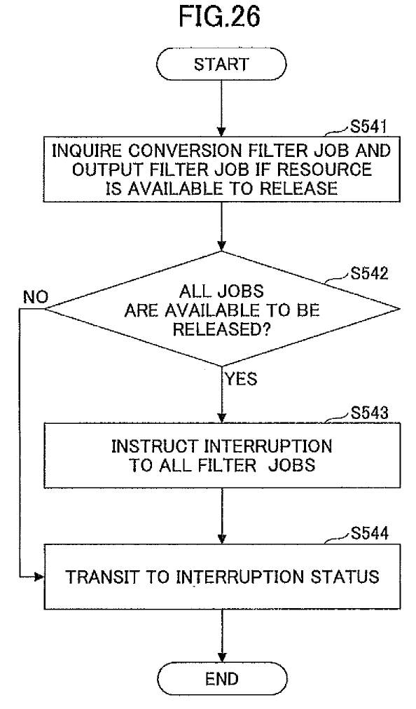

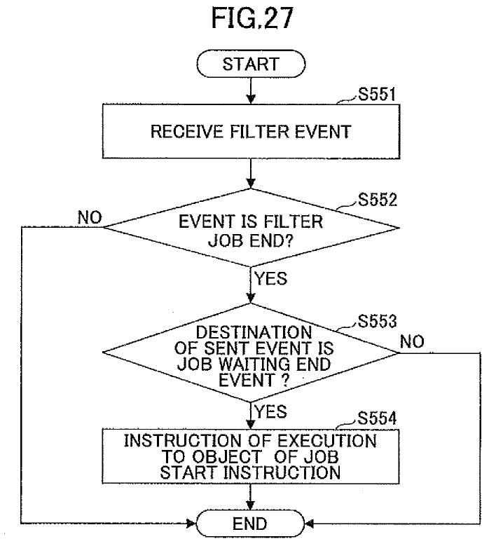

Next, as an example of another event processing at step S507 of FIG. 27, a process by the document operation job object when receiving an interruption of the filter job is described. FIG. 25 is a flowchart to show a process sequence of the event process by the document operation job object when an interruption event is received.

At S521, an event is received from the filter job object. Next, it is determined whether the event is an interruption (S522). If the event is an interruption (YES at S522), it is determined (S523) whether the interruption is caused by a waiting of data on the input side pipe based on information indicating the reason of interruption included in the interruption event. When the interruption is caused by waiting of data to the input side pipe (YES at S523), a switching (transition) process is performed to shift to the determination of the feasibility of releasing the resource and an interrupted state of the document operation job (S524), and the process of FIG. 25 is completed. Further, step 524 is later described in detail.

When the interruption is not caused by a waiting of data input to the input side pipe (No at S523), it is determined whether the job may be restarted based on information indicating restart of event included in the interruption event (S525). If the job may be restarted (YES at S525), it is determined whether the restart instruction (restart instruction of the filter job for the filter job object) is required based on information indicating a restart of the event included in the interruption event (S526). It the restart instruction is required (YES at S526), the necessity of the restart instruction for the filter job object of the sender of the interruption event and the interruption reason are saved in the memory device (S527). If the restart is not necessary (NO at S526), the step 527 is not executed. Then, the document operation job object switches to the interruption state (S528) and the process of FIG. 25 is finished.

On the other hand, if it is determined that the interruption may be restarted (NO at S525), a cancelling job is instructed to all filter job objects (S529) and the process of FIG. 25 is completed.

Also, if the received event is not an interruption event (NO at S522), the process corresponding to the event is performed (S530).

Next, the process of step S524 of FIG. 25 is described in detail. FIG, 26 is a flowchart to describe judgment of release feasibility by the document operation job object and the document operation job's transition process to interruption state.

At step S541, a release feasibility of resources used in each filter job is inquired about for the filter job object of the conversion filter and the output filter. In this case, the resources are, for example, a memory, hardware related to specific process of the filter (e.g. plotter or the like). Next, based on the inquiry result, it is determined whether the resources of all filter jobs may be released (S542). If the resource of all filter jobs are available to release (YES at S542), an interrupting filter job to all filter job objects is instructed (S543). If the resource of at least one filter job is possible to release (NO at S542), step 543 is not executed. Further, the document operation job object switches to interruption state (S544) and the process of FIG. 25 is finished.

Next, at steps S424, S428, S432 or the like in FIG. 23, processes to be executed by the job start trigger object 451 are described FIG. 27 is a flowchart to describe a process sequence of event due to the job start trigger object.

At step S551, an event is received from the filter job object. Next, it is determined whether the event is an end event (S552). If the event is end event (YES at S552), it is determined (S535) whether the filter job object of the sender of the end event corresponds to the filter job object associated as “waiting end event” by association r9 (see FIG. 6). The determination may be executed based on the association r9. When the sender of the event corresponds to the filter job object with a state of “waiting end event” (YES at S553), the filter job object (filter object of the output filter to be executed later) associated as “job start instruction object” by the association r19 (see FIG. 6) is instructed to start execution of the filter job (S554). When the job start trigger object is associated with plural filter objects as “waiting end event”, the job start trigger object instructs the filter job object associated as “job start instruction object” after receiving all end events from the plural filter job object. Also, plural filter job objects are associated as “job start instruction object”, the plural filter job objects are instructed to start execution. Further, if the event is not end event, steps S553 and S554 are not executed.

As described above, according to the multi-function apparatus 1 of this embodiment, as each filter can be constructed as each function, a customizing function and an extending function can be simply performed. In short, there is no functional dependence between each filter, maintaining independence, a new function (application) can be easily developed by addition or combination of other filters. Thus, if a new application is required, only part of a process which does not exist in current applications may be developed to construct the new application to install. Then, for a lower layer than the control layer and the application logic layer 30, a modification frequency can be reduced for modifications caused by additional application installation, and a stable platform can be provided.

Further, by preliminarily defining a function constituted by a combination of filters as an activity, the function constituted by the filter combination (connection) may be utilized with simpler operation.

Further, when the activity includes plural outputs, the process order between the plural output filters having parallel relation for filter connection may be controllable. Thus, flexible control may be possible for filter process order.

Further, for this embodiment, the job start trigger class 450 (job start trigger object 451) is an example of output order control unit. Thus, the association r10 and the association r11 formed between the job start trigger object 451 and the filter job object correspond to output order information.

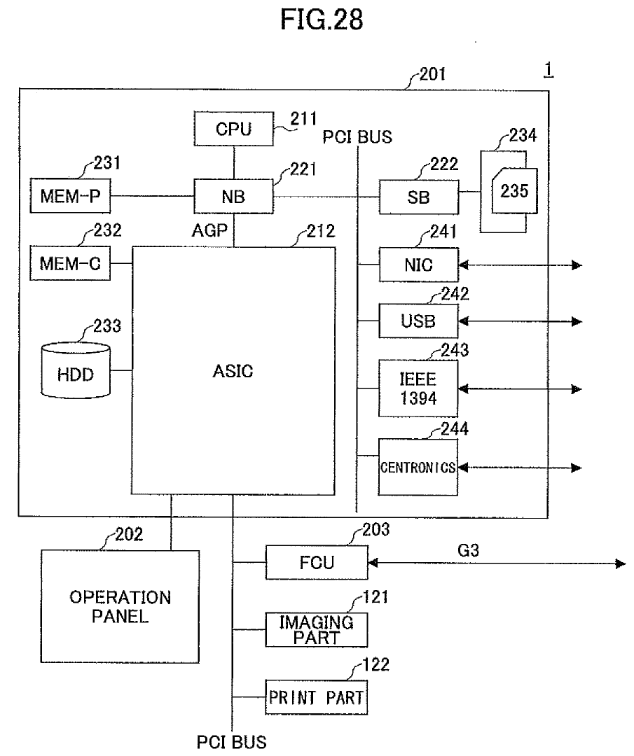

Further, an example is given of the hardware construction of the multi-function apparatus 1. FIG. 28 shows an example of the hardware construction of the multi-function apparatus 1 for this embodiment.

As hardware of the multi-function apparatus 1, there are a controller 201, an operation panel 202, a facsimile control unit (FCU) 203, an imaging part 121, and a print part 122.

The controller 201 is constructed with a CPU 211, an ASIC 212, a NB 221, a SB 222, a MEM-P 231, a MEM-C 232, a HDD (Hard Disk Drive) 233, a memory card slot 234, a NIC (net working interface controller) 241, a USB device 242, an IEEE 1394 device 243, and a centronics device 244.

The CPU 211 may be various types of information processing ICs. The ASIC 212 may be various types of image processing ICs. The NB 221 is a north-bridge of the controller 201. The SB 222 may be a south-bridge of the controller 201. The MEN-P 231 may be a system memory of the multi-function apparatus 1. The MEM-C 232 may be a local memory of the multi-function apparatus 1. The HDD 233 may be a storage unit of the multi-function apparatus 1. The memory slot 234 is configured to set a memory card 235. The NIC 241 may be a controller for network communication of a MAC address. The USB device 242 may provide terminals to connect USB standard connection terminals. The IEEE 1394 device 243 provides IEEE 1394 connection terminals. The Centronics device 244 provides connection terminals for Centronics standard connection terminals. The operation panel 202 may be a hardware (operation part) which an operator inputs into the multi-function apparatus 1 and obtains an output (display part) from the multi-function apparatus.

Further, the software indicated in FIG. 1 or the like is stored, for example, in the MEM-C232, and processed with the CPU 211 and the function is performed by the multi-function apparatus 1.

The present invention is not limited to the specifically disclosed embodiments, and variations and modifications may be made without departing from the scope of the present invention.

The present application is based on Japanese priority application No. 2007-228093 filed on Sep. 3, 2007, the entire contents of which are hereby incorporated herein by reference.

What is claimed is:

1. An image forming apparatus being capable of executing at least one application having a first software unit and a plurality of second software units, comprising:
said first software unit configured to process a process of input of image data;
said plurality of second software units configured to process a process of output of the image data respectively, and;
an output order control unit configured to control an execution order of the plural second software units, based on output order information indicating the execution order of the plurality of second software units.

2. The image forming apparatus as claimed in claim 1, wherein the application unit instructs, in response to start of execution of the application, to start execution of a process for software units excluding the plurality of second software units and at least one of plural second software units established as initial execution objects based on the output order information indicating the execution order, and the output order control unit instructs, in response to a notice from the at least one of the plural second software units having finished the process, based on the output order information, to start execution of a process for a following one of plural second software units to be executed following the at least one of the plural second software units.

3. The image forming apparatus as claimed in claim 2, wherein the application instructs, in response to start execution of the application, to start execution of a process for software units excluding the plurality of second software units and plural second software units established as initial execution objects based on the execution order indicated by the output order information.

4. The image forming apparatus as claimed in claim 2, wherein the output order control unit instructs, in response to a notice from the plural second software units having finished the process, based on the output order information, to start execution of a process for a following one of the plural second software units to be executed following the plural second software units.

5. The image forming apparatus as claimed in claim 2, wherein the output order control unit instructs, in response to notice from the at least one of the plural second software units having finished the process, based on the output order information, to start execution of a process for following plural second software units to be executed following the at least one plural second software units.

6. An image forming control method comprising the steps of:
(a) executing at least a process related to input of image data using a first software unit;
(b) executing a process related to output of the image data using a plurality of second software units; and
(c) controlling an execution order of the plural second software units, based on output order information indicating the execution order of the plural second software units.

7. The image forming control method as claimed in claim 6, wherein the application instructs, in response to start of execution of the application, to start execution of a process for software units excluding the plurality of second software units and at least one of plural second software units established as initial execution objects based on the output order information indicating the execution order, and the output order control unit instructs, in response to a notice from the at least one of plural second software units having finished the process, based on the output order information, to start execution of a process for following one of the at least one of the plural second software units to be executed following the at least one of the plural second software units.

8. The image forming control method as claimed in claim 7, wherein the application instructs, in response to start execution of the application, to start execution of a process for software units excluding the plurality of second software units and plural second software units established as initial execution objects based on the execution order indicated by the output order information.

9. The image forming control method as claimed in claim 7, wherein the output order control unit instructs, in response to a notice from the plural second software units having finished the process, based on the output order information, to start execution of a process for following plural second software units to be executed following the plural second software units.

10. The image forming control method as claimed in claim 7, wherein the output order control unit instructs, in response to notice from the at least one of the plural second software units having finished the process, based on the output order information, to start execution of a process for following plural second software units to be executed following the at least one of the plural second software units.

11. A computer-readable recording medium having instructions executable by a computer to execute an image forming control comprising:
executing at least a process related to input of image data using a first software unit;
executing a process related to output of the image data using a plurality of second software units; and
controlling an execution order of the plural second software units, based on output order information indicating the execution order of the plural second software units.

12. The computer-readable recording medium as claimed in claim 11, wherein the application instructs, in response to start of execution of the application, to start execution of a process for software units excluding the plurality of second software units and at least one of plural second software units established as initial execution objects based on the output order information indicating the execution order, and the output order control unit instructs, in response to a notice from the at least one of the plural second software units having finished the process, based on the output order information, to start execution of a process for following one of the at least one of the plural second software units to be executed following the at least one of the plural second software units.

13. The computer-readable recording medium as claimed in claim 12, wherein the application instructs, in response to start execution of the application, to start execution of a process for software units excluding the plurality of second software units and plural second software units established as initial execution objects based on the execution order indicated by the output order information.

14. The computer-readable recording medium as claimed in claim 12, wherein the output order control unit instructs, in response to a notice from the plural second software units having finished the process, based on the output order information, to start execution of a process for following plural second software units to be executed following the plural second software units.

15. The computer-readable recording medium as claimed in claim 12, wherein the output order control unit instructs, in response to notice from the at least one of the plural second software units having finished the process, based on the output order information, to start execution of a process for following plural second software units to be executed following the at least one of the plural second software units.
